(19) United States
(12) Patent Application Publication
(10) Pub. No.: US 2026/0225968 A1
(43) Pub. Date: Aug. 6, 2026

(54) CROP NUTRITION COMPOSITION COMPRISING MAGNESIUM AND ZINC

(71) Applicant: Komal BHUKHANWALA, Mumbai (IN)

(72) Inventor: Komal BHUKHANWALA, Mumbai (IN)

(21) Appl. No.: 19/128,885

(22) PCT Filed: May 13, 2022
(86) PCT No.: PCT/IB2022/062114

§ 371 Date: May 9, 2025

(30) Foreign Application Priority Data
Nov. 18, 2022 (IN) 202221066607

(51) Int. Cl. C05D 9/02; A01N 59/06; A01N 59/16; A01P 21/00; C05D 5/00; C05G 3/50; C05G 5/12

(52) U.S. Cl. CPC C05D 9/02; A01N 59/06; A01N 59/16; A01P 21/00; C05D 5/00; C05G 3/50; C05G 5/12

(57) ABSTRACT

The present invention relates to a crop nutrition composition in the form of water dispersible granules comprising a homogeneous mixture of one or more of water insoluble Magnesium salt, complex or derivatives thereof in the range of 5%-80% w/w of the total composition and one or more of water insoluble Zinc salt, complex or derivatives thereof in the range of 1%-50% w/w of the total composition with at least one agrochemically acceptable excipient; wherein elemental Zinc is present in the range of 0.01% to 50% w/w of the total composition and wherein elemental Magnesium is present in the range of 0.1% to 50% w/w of the total composition, wherein the granules of the composition comprises particles in the size range of 0.1 micron-30 microns. The present invention relates to a process of preparing the crop nutrition composition and method of treating plants, seeds, crops, plant propagation material, locus, plant parts or soil with the crop nutrition composition.

### FIELD OF THE INVENTION

The present invention relates to a crop nutrition composition in the form of water dispersible granules comprising a homogeneous mixture of an effective amount of one or more of water insoluble Magnesium salt, complex or derivatives thereof and one or more of water insoluble Zinc salt, complex or derivatives thereof with one or more of agrochemically acceptable excipient. The water dispersible granular composition of the present invention comprises particles in the size range of 0.1 micron to 30 microns.

The invention further relates to a water dispersible granular composition comprising a homogeneous mixture of one or more of water insoluble Magnesium salt, complex or derivatives thereof in the range of 5%-80% w/w of the total composition and one or more of water insoluble Zinc salt, complex or derivatives thereof in the range of 1%-50% w/w of the total composition with one or more of agrochemically acceptable excipient; wherein the elemental Zinc is present in the range of 0.01% to 50% by weight of the total composition and wherein the elemental Magnesium is present in the range of 0.1% to 50% by weight of the total composition and wherein the composition comprises of particles in the size range of 0.1 micron to 30 microns.

The present invention relates to a method of improving plant health or enhancing the uptake of nutrient by the plants or plant yield by treating at least one of a plant, a plant propagation material, locus, plant parts, a seed, seedling or surrounding soil with the water dispersible granular composition of the present invention.

### BACKGROUND OF THE INVENTION

In describing the embodiments of the invention, specific terminology is chosen for the sake of clarity. However, it is not intended that the invention be limited to the specific terms so selected and it is to be understood that each specific term includes all technical equivalents that operate in a similar manner to accomplish a similar purpose.

Nutrition is the key element in growth and development of crops. Poor and inadequate availability of nutrients to the plants results in lack of proper growth and physiological development. As a consequence, the plants become more susceptible to attack by pests. Other problems associated with agriculture are environmental conditions such as drought, biotic and abiotic stress, poor soil condition or depletion of nutrients in the soil which lead to reduction in the yield and quality of produce. Thus, providing adequate and balanced nutrition in a manner such that there is maximum uptake of nutrient by the plant, along with protection to the crops remains a great challenge. Optimizing the soil condition and managing the use of crop nutrients has been a long felt need of farmers to improve the nutrient use efficiency of crops. Significant research is being carried out so as to improve soil and plant health, provide better economic returns to farmers and also reduce the burden on the environment because of rampant use of synthetic pesticides.

In parallel, hidden hunger and micronutrient deficiencies across population in all major continents is rampant which contribute substantially to the global burden of diseases. Amongst the micronutrient deficiencies that people are normally suffering across the globe. 17.3% of the world's population is at risk of inadequate zinc intake (A shish Sharma, Babita Patni, et al. 2012). One of the key underlying causes of this is the imbalanced fertilizer practice. Excessive and indiscriminate application of nutrients can cause severe imbalance and antagonism which results in nutrient deficient produce. It is thus a herculean and challenging task to grow food in quantity while maintaining quality in terms of nutrient content.

The role of micronutrients as an essential element required for growth and reproduction by plants has been long known. Micronutrients plays an important role in balancing the crop nutrition. Further, it is also known that optimum levels of nutrients are required for the normal functioning, growth of the plants and any variance in the nutrient levels may cause hindrance in overall crop growth and cause its health to decline due to either a deficiency or toxicity in turn affecting the nutrients essential for human diet. Due to low availability of minerals & nutrients in soil and/or low accumulation/bio-availability of minerals & elements in edible parts of the crops, it is estimated that nearly 2 billion people are suffering from deficiency of micronutrients such as Iron, Zinc [Graham et al; 2012; ‘How much nutritional Iron deficiency in humans globally is due to an underlying Zinc deficiency’]. Furthermore, poor availability of fertilizers or nutrients to the plants also results in a lack of proper growth, resulting in the plants becoming more susceptible to attack by pests.

Besides the low concentration of essential micronutrients in soil, one of the root causes for the deficiency is the low availability of micronutrients in its oxidized form to plant roots. Further, other factors responsible for limiting availability of essential nutrients from the soil include leaching of water-soluble nutrients due to rain and irrigation, variable carbonate levels in soil, soil salinity, soil moisture, soil alkalinity, low temperature and concentration of other elements i.e. ‘competitive microelements’ which lead to the deficiency of the micronutrients. Further, the ability of plants to respond to the availability of micronutrients ultimately affects human nutrition, both in terms of crop yield and the micronutrient concentration in the edible tissues. Therefore, proper nutrition is critical for optimizing the plant nutrition and metabolism, which in turn contributes to the overall crop yield, quality and nutrient rich human diet. Magnesium (Mg) is an essential macro element that is necessary for plant growth, health and development. Magnesium is involved in several different processes, including photosynthesis. The most important role of Magnesium is as a central atom or heart in the chlorophyll molecule. Without Magnesium, chlorophyll cannot capture Sun's energy required for photosynthesis. Magnesium also helps to activate specific enzyme system which are involved in a plant's normal metabolism. Furthermore, it is also needed for cell division and protein formation and is an essential component for plant respiration.

The availability of Magnesium in the soil depends on multiple factors. One of them being the source rock material, mobility in soil, the degree of weathering, local climate and specific agricultural system, its management practices, such as crop type, cropping intensity, cropping rotation and fertilization practices. Due to its high mobility within the plant, Magnesium deficiency symptoms appear first on the lower and older leaves, before the symptoms become visible on the younger leaves. The symptoms show up as yellow leaves with green veins and around the edges (i.e. interveinal chlorosis). Purple, red or brown spots may also appear on the leaves. Magnesium and its importance in crop production and agriculture has been overlooked for some time, even though it is an essential element for plant growth and development. This is due to the fact that it is difficult to detect latent Magnesium deficiency. Magnesium deficiency is a frequently occurring limiting factor for crop production due to low levels of exchangeable Magnesium (ex-Mg) in acidic soil, which negatively affects sustainability of agriculture development. Magnesium deficiency is problem inherent in acidic soils due to the high saturation of the soil, cationic exchange capacity with H+ ions and consequent Magnesium leaching for long time periods and impaired Mg uptake. The most important agronomic tool to cope with soil acidity in order to address Magnesium deficiency is liming. However, depending on the lime type considerable amounts of Magnesium and Calcium reach the soil which may then interfere with the uptake of other cations such as Zinc, Iron through antagonistic effects. Magnesium deficiency is further enhanced in soil dominated by long term NPK fertilizer practice which caused significant reduction in soil pH. Thus, agricultural soil with good Magnesium condition is the pre-requisite to ensure Magnesium uptake by crop roots and its transfer to edible parts of plants or crops which ultimately provides nutritive food for humans.

The role of Zinc (Zn) as an essential micronutrient has also been long known. It is an important constituent of several enzymes, proteins that are responsible for driving many metabolic reactions in crops and also crucial to plant development. Zinc activates enzymes that are responsible for the synthesis of certain proteins. It is used in the formation of chlorophyll and some carbohydrates, conversion of starches to sugars and its presence in plant tissue helps the plant to withstand cold temperatures. Zinc is an essential element in the formation of auxins which help with growth regulation and stem elongation.

However, Zinc is immobile in the soil due to which the deficiency symptoms occur in the new leaves. Typically, they are expressed as some varying pattern of chlorosis of the new leaves (often interveinal) and necrotic spots may form on the margins or leaf tips which results in formation of leaves which are smaller in size and often cupped upward or distorted. The symptoms also include poor bud development resulting in reduced flowering and branching, shorter internodes, giving a rosette appearance to the plant. Carbohydrate, protein, and chlorophyll formation is significantly reduced in Zinc-deficient plants. The deficiency of Zinc in soil is further due to the number of soil factors such as neutral to alkaline soil condition, high bicarbonate or magnesium concentration in soil, high phosphate levels, high calcium carbonate content in soil etc. which affects its availability in plants [P. Arunachalam, P. Kannan et al; 2012; ‘Zinc deficiency in Indian soils with special focus to enrich Zinc in peanuts’]. Further, excess of Phosphorous (in acidic soils on account of long-term application of NPK fertilizers) is known to lock and limit the availability of Zinc [Ramiro Recena, Antonio Delgado et al; 2021; titled, ‘Zinc uptake by Plants as Affected by Fertilization with Zn Sulfate, Phosphorous availability and Soil properties’]. Moreover, while acidic soil management practices involve the use of lime to balance or increase the soil pH, over liming can cause deficiency of Zinc along with other micronutrients such as Iron, Boron etc. Since, there is a strong correlation between soil Zn status and human Zn deficiency levels, a constant and continuous supply of Zinc is needed for optimum growth and maximum yield.

Moreover, Imbalanced fertilizer practice is further exacerbating the deficiency of Zinc and Magnesium affecting its availability in crops and ultimately hampering human diet. In India, about 25% of the total population suffers from Zinc deficiency. The prevalence of nutritional stunting due to Zinc deficiency is about 47.9% in children of below 5-year age while it is 33% in the world's population.

Thus, it is imperative to apply balance amounts of the most limiting nutrients especially Zinc and Magnesium to crops at various stages and also in the final harvest to obtain the highest yield while minimizing nutrient losses as well as to address the hidden hunger and nutrient deficiency in humans.

Though the benefits of micronutrients are well known, its deficiency has become widespread over the past several decades in most of the agricultural areas of the world, resulting in micronutrients being indicated as a limiting factor to improve plant growth, high yield and fertilizer efficiency.

In addition to this, the interaction among plant nutrients can either be antagonistic or synergistic depending upon the mixture of elements and its composition, concentration etc. and that may influence nutrient use efficiency. Due to application of excess nutrients, plants may suffer from “nutrient antagonism” whereby an excess of a particular element may block the absorption of another element required by the plant and can happen with elements of a similar size and charge (positive or negative) which can result into deficiencies in the plant. Some of the most common antagonisms are Iron blocking Zinc, Manganese (or the reverse), Magnesium blocking Calcium (or the reverse), Phosphorous blocking both Zinc, Iron and Potassium blocking both Magnesium and Calcium. There are literatures which report antagonism between iron and zinc titled, ‘Effects of Zinc on translocation of Iron in soyabean plants; Ambler. J. E., Brown J. C, et al; 1970. Another reason for a plant being deficient is “Binding” which occurs when elements mix together and bond, forming a compound that is insoluble and cannot be absorbed by plant's roots. Further, there is reported antagonism between Zinc and Magnesium. One of the articles titled “Effects of Nutrient Antagonism and Synergism on Yield and Fertilizer Use Efficiency; René P. J. J. Rietra, Marius Heinen et al; 2017” reports the antagonism between Zinc and Magnesium. Thus, knowing the antagonism between Zn—Mg, it has always been challenging to develop an agricultural composition that overcome this problem and successfully meet the nutritional requirement of plants and finally the human diet.

Agricultural compositions which include micronutrient combinations are known in the art mostly in the form of powder or dust wherein the micronutrients are blended and mixed together. However, such powder-based compositions would lead to a non-uniform or non-homogeneous mixture of actives which may not be desirable in terms of its application and also poor uptake of the nutrition by the plants. Powder composition not only have issues with respect to practical application like generation of dust but also pose risk to the users mostly because of eye irritation, inhalation risk and skin irritation. Such formulations are also not easily dispersible and tend to clog the nozzles when applied via drip, making it unsuitable for use in irrigation system. Further, these compositions have also been found to have poor suspensibility which lead to random and non-uniform distribution of active ingredient on the target area which would cause undesirable effects and pose a problem in effective delivery of nutrients to the plant or crop and are also required to be used in large amounts.

There are granular or powder compositions known in the art which involve the use of water-soluble nutrients. However, such compositions during heavy rainfall or irrigation tend to wash away and fail to be absorbed by the plants which in turn causes ground water contamination. As soils become more saline, plants are unable to draw as much water and nutrients from the soil. This results not only in a marked loss of efficiency but also has serious environmental consequences.

Compositions comprising fertilizer granules coated with micronutrient mixtures or water disintegrable granules of micronutrients are also known in the art. However, such compositions are designed in a manner such that they release the actives very slowly making the actives locked in the soil for prolonged period of time depriving the plant of their immediate nutritional requirement. As a consequence of the nutritional deficiency in the plants during their infancy, it makes them susceptible to various diseases eventually stunting their growth and yield. Further, water disintegrable granular compositions owing to non-uniform disintegration and distribution of particles suffer from their own set of drawbacks. On account of disintegration into random and non-uniform particles sizes, such compositions tend to clog the nozzles when applied via drip, making it unsuitable for use in modern day irrigation system.

Conventionally, micronutrient-based compositions are also known in the art in the form of bentonite granules or pastilles, pellets, granules prepared through molten process etc. Such products of micronutrient combinations in the form of granules or pellets or pastilles comprises of swelling clays and have been associated with several drawbacks. These compositions are generally bigger in size and include swelling clay which swell on contact with moisture and disintegrate into large particles of uneven size. Such granules or pastilles also lead to an irregular release of the micronutrients not meeting the plant nutritional requirement and eventually resulting in poor field efficacy. A gain, these types of micronutrient compositions are only suitable for broadcast applications, owing to their own disadvantages namely poor dispersion and suspensibility in water because of its disintegration into larger particle size, resulting in nozzle clogging in spray applications, posing a problem in delivery of nutrients to the plants or the crops. Due to these drawbacks, such prior art compositions containing micronutrients have negligible commercially viability or applicability in drip or sprinkler irrigation system which today is an essential mode of irrigation on account of labour shortage and water scarcity.

Furthermore, other formulations disclosed in the art would direct a person to arrive at liquid compositions. However, such compositions carry low load of active due to the presence of large amount of solvents as a carrier and thus not very effective to meet the nutritional requirement of plant. Also, being liquid, they are not viable while transportation of large quantities of such products.

No suitable water dispersible granular composition comprising Magnesium in combination with Zinc is known, which would make them available to the plant in effective quantities thus meeting the balance nutritional requirement of plants and address the drawbacks like nutrient antagonism of such compositions known in the art.

The present inventors surprisingly found that the composition of the present invention comprising Magnesium and Zinc was not only effective in overcoming the antagonism amongst these individual nutrients but also exhibited synergistic effect. It was found that the composition of the present invention when formulated at a specific particle size made the nutrients Magnesium and Zinc readily available for uptake by the plants.

It was observed that the surprising effect was noted when the present composition comprising a combination of water insoluble salts, complex or derivatives thereof of Magnesium and Zinc in specific proportions was formulated into a water dispersible granular form along with a specific particle size distribution. The composition of the present invention was found to address the challenges of nutrient antagonism in the soil namely between Magnesium and Zinc, Magnesium and Potassium etc.

The present composition was further observed to prevent the leaching of these nutrients and make them available to the fullest extent for the uptake by crops and increase the overall yield. It was further surprisingly noted by the inventors that the present composition also addresses the unavailability of Zinc on account of excess of Phosphorous in highly acidic soils due to the long-term application of NPK fertilizers. The present composition not only facilitates the uptake of Zinc which was locked in such soil but also makes available the other nutrients which are trapped in soil.

The composition of the present invention was found to play a vital role in facilitating the uptake of nutrients even in soils which have been degraded or whose pH have been altered because of excessive use of synthetic fertilizers. In particular, the composition of the present invention surprisingly overcomes the problems of providing adequate amount of Zinc and Magnesium for the crops which was observed on account of excessive practice of NPK fertilizer which limit the availability of Magnesium and Zinc. The composition of the present invention met the nutritional need of plants by providing a balanced uptake of essential nutrients like Zinc and Magnesium. It was further surprising to observe that the balanced uptake of nutrients leads to a healthier plant that could withstand pest infestation, a higher nutrient harvest in all soils types and finally improving the overall soil health. The present composition acts as a nutrient use efficient composition while meeting the need of crops by providing a multi nutritive solution with improved uptake by crops in a single application.

The inventors of the present application have determined that the crop nutrition composition in the form of water dispersible granules comprising a homogeneous mixture of an effective amount of one or more of water insoluble Magnesium salt, complex or derivatives thereof and an effective amount of one or more of water insoluble Zinc salt, complex or derivatives thereof with one or more of agrochemically acceptable excipient; wherein the composition comprises particles in the size range of 0.1 micron to 30 microns demonstrate excellent field efficacy.

The composition of the present invention also exhibits superior physical characteristics such as suspensibility, dispersibility and wettability.

### SUMMARY OF THE INVENTION

The inventors have determined that a crop nutrition composition in the form of water dispersible granules comprising a homogeneous mixture of an effective amount of one or more of water insoluble Magnesium salt, complex or derivatives thereof and an effective amount of one or more of water insoluble Zinc salt, complex or derivatives thereof with at least one agrochemically acceptable excipient provides the nutrients Magnesium and Zinc readily available for uptake by the plants and increase the overall yield in various crops and improves plant physiological parameters.

The water dispersible granular composition of the present application comprises a homogeneous mixture of one or more of water insoluble Magnesium salt, complex or derivatives thereof in a concentration range of 5% to 80% by weight of the total composition, one or more water insoluble Zinc salt, complex or derivatives thereof in a concentration range of 1% to 50% by weight of the total composition and one or more of agrochemically acceptable excipient, wherein the elemental Zinc is present in the range of 0.01% to 50% by weight of the total composition and wherein the elemental Magnesium is present in the range of 0.1% to 50% by weight of the total composition.

Further, the water dispersible granular crop nutrition composition disperses into the particles in the size range of 0.1 micron to 30 microns when comes in contact with water.

Furthermore, the invention relates to a process for preparing a crop nutrition composition in the form of water dispersible granules comprising a homogeneous mixture of an effective amount of one or more of water insoluble Magnesium salt, complex or derivatives thereof and an effective amount of one or more of water insoluble Zinc salt, complex or derivatives thereof with an effective amount of one or more of agrochemically acceptable excipient.

The present invention relates to a method of improving plant health or enhancing the uptake of nutrient by the plants or plant yield by treating at least one of a plant, a plant propagation material, locus, plant parts, a seed, seedling or surrounding soil with the water dispersible granular composition of the present invention.

On account of superior physical characteristics such as suspensibility, dispersibility and wettability exhibited, the composition of the present invention also finds a direct use in micro irrigation or drip irrigation systems.

### DESCRIPTION OF THE INVENTION

In describing the embodiment of the invention, specific terminology is chosen for the sake of clarity. However, it is not intended that the invention be limited to the specific terms so selected and it is to be understood that such specific terms include all technical equivalents that operate in a similar manner to accomplish a similar purpose. It is understood that any numerical range recited herein is intended to include all subranges subsumed. Also, unless denoted otherwise percentage of components in a composition are presented as weight percent or total weight of the composition. Further, the active dosage of Zinc and Magnesium in a composition applied in the field experiment is of elemental Zinc and Magnesium.

The terms “a” or “an”, as used herein, are defined as one or more than one. The terms “including” and/or “having”, as used herein, are defined as comprising (i.e., open language).

The term “plant” or “crop” used in this application are interchangeable and wherever the term “plant” has been used shall also mean vegetations of similar nature namely crops, trees, shrub, herb etc.

The term ‘derivatives’ used in this application shall also encompass the minerals containing Zinc, the minerals containing Magnesium etc.

The term ‘salts’ used in this application shall also encompass the compounds containing Zinc, Magnesium. The compounds of Zinc can include Zinc Oxide and the compounds of Magnesium can include Magnesium Oxide.

Nutrient Use Efficiency (NUE) is defined as a measure of how well plants use the available mineral nutrients. Improvement of NUE is an essential pre-requisite for expansion of crop production into marginal lands with low nutrient availability but also a way to reduce use of inorganic fertilizer.

A water dispersible granule is defined as a formulation that disperses or dissolves readily when added to water to give a fine particle suspension. As described herein, “WG” or “WDG” refer to water dispersible granules. Water-dispersible granules are formulated as small, easily measured granules (an agglomeration of fine particles) by blending and agglomerating a ground solid active ingredient together with surfactants and other formulation ingredients which disperse into finer/primary particles when immersed in water. The water-dispersible granules are obtained by spray drying or by extrusion process.

A mixture is defined as a combination of two or more substances that are not chemically united to each other. A homogeneous mixture is defined as the one whose composition is uniform throughout the mixture. It is the type of mixture where the composition is constant throughout or the components that make up the mixture are distributed uniformly.

The present invention relates to a composition for crop nutrition in the form of water dispersible granules comprising a homogeneous mixture of one or more of water insoluble Magnesium salt, complex or derivatives thereof and one or more of water insoluble Zinc salt, complex or derivatives thereof with at least one agrochemically acceptable excipient.

The water dispersible granular composition of the present invention includes a homogeneous mixture of 5% to 80% by weight of one or more water insoluble Magnesium salt, complex or derivative thereof, 1% to 50% by weight of one or more water insoluble Zinc salt, complex or derivatives thereof and at least one agrochemically acceptable excipient, wherein the elemental Zinc is present in the range of 0.01% to 50% by weight of the total composition and wherein the elemental Magnesium is present in the range of 0.1% to 50% by weight of the total composition. Further, the said crop nutrition composition when added to water disperses into fine particles in the size range of 0.1 micron to 30 microns and exhibits improved dispersibility and suspensibility. According to an embodiment, the agrochemical excipient is surfactant.

The present inventors surprisingly found that the present composition in the form of water dispersible granules comprising Magnesium and Zinc together is not only effective but also synergistic. It was also noted by the present inventors that the application of the composition renders a greater and balanced uptake of nutrients.

It was observed that the surprising effect was noted when the present composition comprising a combination of water insoluble salts, complex or derivatives of Magnesium and Zinc in specific proportions was formulated into a water dispersible granular form along with a specific particle size distribution.

It was further surprisingly noted by the inventors that the present composition also addresses the unavailability of Zinc due to presence of excess of other competitive nutrients such as Phosphorous in highly acidic soils on account of the long-term application of NPK fertilizers. The present composition not only facilitates the uptake of Zinc which was locked in such soil but also makes available other nutrients which are trapped in soil. The present composition was further observed to prevent the leaching of these nutrients and make them available to the fullest extent for the uptake by crops and increase the overall yield.

According to an embodiment, the crop nutrition composition is in the form of water dispersible granules, wherein the granules are in the size range of 0.05 mm to 5.0 mm. According to an embodiment, the crop nutrition composition is in the form of water dispersible granules, wherein the granules are in the size range of 0.05 mm to 4.0 mm. According to further embodiment, the crop nutrition composition is in the form of water dispersible granules, wherein the granules are in the size range of 0.05 mm to 3.0 mm. Preferably, the crop nutrition composition is in the form of water dispersible granules, wherein the granules are in the size range of 0.05 mm to 2.5 mm. Preferably, the crop nutrition composition is in the form of water dispersible granules, wherein the granules are in the size range of 0.05 mm to 2 mm. Preferably, the crop nutrition composition is in the form of water dispersible granules, wherein the granules are in the size range of 0.05 mm to 1.5 mm. Preferably, the crop nutrition composition is in the form of water dispersible granules, wherein the granules are in the size range of 0.05 mm to 1 mm. M ore preferably, the crop nutrition composition is in the form of water dispersible granules, wherein the granules are in the size range of 0.05 mm to 0.5 mm.

According to an embodiment, the crop nutrition composition in the form of water dispersible granules when added to water disperses into particles in the size range of 0.1 micron to 30 microns, preferably into the particles in the size range of 0.1 micron to 25 microns, more preferably in the size range of 0.1 micron to 20 microns. It was further observed that the present composition when formulated at a specific particle size of 0.1 micron to 30 microns, made the nutrients Magnesium and Zinc readily available for uptake by the plants and increase the overall yield. Thus, the particle size range of 0.1 micron to 30 microns of the crop nutrition composition was found to be important not only in terms of ease of application but also in terms of efficacy.

According to another embodiment, the crop nutrition composition of the present invention in the form of water dispersible granules comprises particles having diameter distribution of D50 of about 20 microns, more preferably, the water dispersible granules comprises particles having diameter distribution of D50 of about 10 microns.

According to an embodiment, the water dispersible granular crop nutrition composition is in the form of microgranules, wherein the granules disperses into the fine particles in the size range of 0.1 micron to 30 microns.

According to an embodiment, the water-insoluble Zinc salts include one or more of but not limited to Zinc Oxide, Zinc Carbonate, Zinc Sulphide, Zinc Molybdate, Zinc Phosphate, Zinc Nitrilotriacetic Acid (NTA), Zinc Borate, Zinc Silicate, Zinc Pyrophosphate, Zinc Citrate, complex or derivatives thereof. However, those skilled in the art will appreciate that it is possible to utilize other water insoluble Zinc salts, complexes or derivatives thereof without departing from the scope of the invention.

According to an embodiment, the water insoluble Zinc salt, complex or derivatives thereof include one or more of Zinc containing minerals selected from but not limited to Zinc ores including one or more of Periclase, Danbaite, Ashoverite, Sphalerite, Wurtzite. However, the above list of ores or minerals is exemplary and not meant to limit the scope of the invention.

According to an embodiment, the water insoluble Zinc salt, complex, derivative or mixture thereof is present in the range of 1% to 50% by weight of the total composition. According to an embodiment, the water insoluble Zinc salt, complex, derivative or mixtures thereof is present in the range of 1% to 40% by weight of the total composition. According to an embodiment, the water-insoluble Zinc salt, complex, derivative or mixtures thereof is present in the range of 1% to 30% by weight of the total composition. According to an embodiment, the water-insoluble Zinc salt, complex, derivative or mixtures thereof is present in the range of 1% to 20% by weight of the total composition. According to an embodiment, the water-insoluble Zinc salt, complex, derivative or mixtures thereof is present in the range of 1% to 10% by weight of the total composition. According to an embodiment, the water insoluble Zinc salt, complex, derivative or mixtures thereof is present in the range of 1% to 5% by weight of the total composition. According to an embodiment, the water insoluble Zinc salt, complex, derivative or mixtures thereof is present in the range of 3% to 50% by weight of the total composition. According to an embodiment, the water insoluble Zinc salt, complex, derivative or mixtures thereof is present in the range of 3% to 40% by weight of the total composition. According to an embodiment, the water insoluble Zinc salt, complex, derivative or mixtures thereof is present in the range of 3% to 30% by weight of the total composition. According to an embodiment, the water insoluble Zinc salt, complex, derivative or mixtures thereof is present in the range of 3% to 20% by weight of the total composition. According to an embodiment, the water insoluble Zinc salt, complex, derivative or mixtures thereof is present in the range of 3% to 10% by weight of the total composition.

According to an embodiment, the water insoluble Zinc salt, complex, derivative or mixture thereof is present in the range of 1% to 50% by weight of the total composition wherein the elemental Zinc is present in the range of 0.01% to 50% by weight of the total composition.

According to further embodiment, the water insoluble Zinc salt, complex, derivative or mixture thereof is present in the range of 1% to 50% by weight of the total composition wherein the elemental Zinc is present in the range of 0.01% to 45% by weight of the total composition.

According to a further embodiment, the water insoluble Magnesium salts include one or more of but not limited to Magnesium Molybdate, Magnesium Hydroxide (Milk of Magnesia), Calcium Magnesium Phosphate, Magnesium Phosphate Tribasic, Magnesium Carbonate, Magnesium Aluminium Silicate, Calcium Magnesium Silicate, Magnesium Trisilicate, Magnesium Phosphate, Magnesium Silicate, Magnesium Oxide, complex or derivatives thereof. However, those skilled in the art will appreciate that it is possible to utilize other water insoluble Magnesium salts, complexes, derivatives or mixtures thereof without departing from the scope of the invention.

According to an embodiment, the water insoluble Magnesium salts, complex or derivatives thereof include one or more of Magnesium-containing minerals selected from but not limited to Magnesium ores including one or more of Periclase, Brucite, Sellaite, Kotoite, Pertsevite, Suanite, Magnesite, Szaibélyite, Neighborite. However, the above list of ores or minerals is exemplary and not meant to limit the scope of the invention.

According to an embodiment, the water insoluble Magnesium salt, complex, derivative or mixture thereof is present in the range of 5% to 80% by weight of the total composition wherein the elemental Magnesium is present in the range of 0.1% to 50% by weight of the total composition.

According to an embodiment, the water insoluble Magnesium salt, complex, derivative or mixtures thereof is present in the range of 5% to 80% by weight of the total composition. According to an embodiment, the water insoluble Magnesium salt, complex, derivative or mixtures thereof is present in the range of 5% to 70% by weight of the total composition. According to an embodiment, the water insoluble Magnesium salt, complex, derivative or mixtures thereof is present in the range of 5% to 60% by weight of the total composition. According to an embodiment, the water insoluble Magnesium salt, complex, derivative or mixtures thereof is present in the range of 5% to 50% by weight of the total composition. According to an embodiment, the water insoluble Magnesium salt, complex, derivative or mixtures thereof is present in the range of 5% to 40% by weight of the total composition. According to an embodiment, the water insoluble Magnesium salt, complex, derivative or mixtures thereof is present in the range of 5% to 30% by weight of the total composition. According to an embodiment, the water insoluble Magnesium salt, complex, derivative or mixtures thereof is present in the range of 5% to 20% by weight of the total composition. According to an embodiment, the water insoluble Magnesium salt, complex, derivative or mixtures thereof is present in the range of 5% to 10% by weight of the total composition.

According to another embodiment, the crop nutrition composition in the form of water dispersible granules comprises a homogeneous mixture of one or more of water insoluble Magnesium salt, complex or derivatives thereof in the range of 5% to 80% by weight of the total composition and one or more of water insoluble Zinc salt, complex or derivatives thereof in the range of 1% to 50% by weight of the total composition and one or more surfactant in the range of 1% to 40% by weight of the total composition.

According to an embodiment, the crop nutrition composition in the form of water dispersible granules comprises a homogeneous mixture of one or more of Magnesium Oxide or Magnesium Silicate or Magnesium Carbonate or Magnesium Phosphate or Magnesium Hydroxide in the range of 5% to 80% by weight of the total composition and one or more of Zinc Oxide or Zinc Carbonate or Zinc Silicate or Zinc Hydroxide or Zinc Phosphate in the range of 1% to 50% by weight of the total composition with one or more agrochemically acceptable excipient; wherein the composition comprises particles in the size range of 0.1 micron to 30 microns.

According to an embodiment, the crop nutrition composition in the form of water dispersible granules comprises a homogeneous mixture of one or more of Magnesium Oxide or Magnesium Silicate or Magnesium Carbonate or Magnesium Phosphate or Magnesium Hydroxide in the range of 5% to 80% by weight of the total composition and one or more of Zinc Oxide or Zinc Carbonate or Zinc Silicate or Zinc Hydroxide or Zinc Phosphate in the range of 1% to 50% by weight of the total composition with one or more surfactant in the range of 1% to 40% by weight of the total composition, wherein the composition comprises particles in the size range of 0.1 micron to 30 microns.

According to an embodiment, the crop nutrition composition may further comprise at least one additional water insoluble plant nutrient.

According to an embodiment, the additional water insoluble plant nutrient is present in the range of from 0.01% to 40% by weight of the total composition.

According to an embodiment, the crop nutrition composition is devoid of fertilizers that primarily comprise of alginic acid or urea or humic acid or phosphorus pentoxide or sulphur or other conventional fertilizers.

According to an embodiment, the crop nutrition composition is devoid of water insoluble Iron salt or Boron salt or their complexes or derivatives thereof.

According to an embodiment, the crop nutrition composition in the form of water dispersible granules comprises a homogeneous mixture of one or more of water insoluble Magnesium salt, complex or derivatives thereof in the range of 5% to 80% by weight of the total composition and one or more of water insoluble Zinc salt, complex or derivatives thereof in the range of 1% to 50% by weight of the total composition with one or more agrochemically acceptable excipient; wherein the composition comprises particles in the size range of 0.1 micron to 30 microns; wherein the composition is devoid of one or more of water insoluble Iron salt or complex or derivatives thereof.

According to an embodiment, the crop nutrition composition in the form of water dispersible granules comprises at least one agrochemical excipient. According to further embodiment, the agrochemically acceptable excipients which are used in water dispersible granular formulation include at least one wetting agent, surfactant, emulsifier, dispersing agent, hydrocolloids, binder or filler or carrier or diluent, disintegrating agent, buffer or pH adjuster or neutralizing agent, antifoaming agent, anti-settling agent, anticaking agent, penetrating agent, sticking agent, tackifier, pigment, colorant, stabilizer and mixtures thereof. According to an embodiment, the surfactants include one or more of anionic, cationic, non-ionic, amphoteric and polymeric surfactants. According to an embodiment, the surfactants include one or more of emulsifiers, wetting agents and dispersing agents. However, those skilled in the art will appreciate that it is possible to utilize additional agrochemically acceptable excipients without departing from the scope of the present invention. The agrochemically acceptable excipients are commercially manufactured and available through various companies.

According to an embodiment, the agrochemical excipients are present in a concentration range of 0.01% to 94% by weight of the total composition. According to an embodiment, the agrochemical excipients are present in a concentration range of 0.01% to 90% by weight of the total composition.

According to an embodiment, the agrochemical excipients are present in a concentration range of at least 94% by weight of the total composition. According to an embodiment, the agrochemical excipients are present in a concentration range of at least 90% by weight of the total composition. According to an embodiment, the agrochemical excipients are present in a concentration range of at least 75% by weight of the total composition. According to an embodiment, the agrochemical excipients are present in a concentration range of at least 55% by weight of the total composition. According to an embodiment, the agrochemical excipients are present in a concentration range of at least 35% by weight of the total composition. According to an embodiment, the agrochemical excipients are present in a concentration range of at least 25% by weight of the total composition. According to an embodiment, the agrochemical excipients are present in a concentration range of at least 15% by weight of the total composition. According to an embodiment, the agrochemical excipients are present in a concentration range of at least 5% by weight of the total composition. According to an embodiment, the agrochemical excipients are present in a concentration range of at least 1% by weight of the total composition. According to an embodiment, the agrochemical excipients are present in a concentration range of at least 0.1% by weight of the total composition

According to an embodiment, the surfactants which are used in the crop nutrition composition include one or more of emulsifiers, wetting agents and dispersing agents. According to an embodiment, the surfactants which are used in the composition include one or more of anionic, cationic, non-ionic, amphoteric, polymeric surfactants.

The anionic surfactants include one or more of but not limited to a salt of Fatty Acid, a Benzoate, a Polycarboxylate, a salt of Alkylsulfuric Acid Ester, Alkyl Ether Sulfates, an Alkyl Sulfate, an Alkylarylsulfate, an Alkyl Diglycol Ether Sulfate, a Salt of Alcohol Sulfuric Acid Ester, an Alkyl Sulfonate, an Alkylaryl Sulfonate, an Aryl Sulfonate, a Lignin Sulfonate, an Alkyl Diphenyl Ether Disulfonate, a Polystyrene Sulfonate, a Salt Of Alkylphosphoric Acid Ester, an Alkylaryl Phosphate, a Styrylaryl Phosphate, Sulfonate Docusates, a Salt Of Polyoxyethylene Alkyl Ether Sulfuric Acid Ester, a Polyoxyethylenealkyl aryl Ether Sulfate, Alkyl Sarcosinates, Alpha Olefin Sulfonate Sodium Salt, Alkyl Benzene Sulfonate or Its Salts, Sodium Lauroylsarcosinate, Sulfosuccinates, Polyacrylates, Polyacrylates-Free Acid and Sodium Salt, Salt of Polyoxyethylenealkylaryl Ether Sulfuric Acid Ester, a Polyoxyethylene Alkyl Ether Phosphate, a Salt of Polyoxyethylenealkylaryl Phosphoric Acid Ester, Sulfosuccinates-M ono and other Diesters, Phosphate Esters, Alkyl Naphthalene Sulfonate-Isopropyl and Butyl Derivatives, Alkyl Ether Sulfates-Sodium And Ammonium Salts; Alkyl Aryl Ether Phosphates, Ethylene Oxides and Its Derivatives, a salt of Polyoxyethylene Aryl Ether Phosphoric Acid Ester, Mono-Alkyl Sulphosuccinates, Aromatic Hydrocarbon Sulphonates, 2-Acrylamido-2-Methylpropane Sulfonic Acid, Ammonium Laurylsulphate, Docusate, Disodium Cocoamphodiacetate, Magnesium Laurethsulfate, Phospholipid, Potassium Lauryl Sulfate, Soap, Soap Substitute, Sodium Alkyl Sulfate, Sodium Dodecyl Sulfate, Sodium Dodecylbenzenesulfonate, Sodium Laurate, Sodium Laurethsulfate, Sodium Lauroylsarcosinate, Sodium Myrethsulfate, Sodium Nonanoyloxybenzenesulfonate, Alkyl Carboxylates, Sodium Stearate, Alpha Olefin Sulphonates, Naphthalene Sulfonate Salts, Alkyl Naphthalene Sulfonate Fatty Acid salts, Naphthalene Sulfonate Condensates-Sodium salt, Fluoro Carboxylate, Fatty Alcohol Sulphates, Alkyl Naphthalene Sulfonate Condensates—Sodium Salt, A Naphthalene Sulfonic Acid Condensed with Formaldehyde or a Salt of Alkylnaphthalene Sulfonic Acid condensed with Formaldehyde, salts or derivatives thereof.

The non-ionic surfactants include one or more of but not limited to Polyol Esters, Polyol Fatty Acid Esters, Polyethoxylated Esters, Polyethoxylated Alcohols, Ethoxylated and Propoxylated Fatty Alcohols, Ethoxylated and Propoxylated Alcohols, Ethylene Oxide (EO)/Propylene Oxide (PO) Copolymers; EO and PO Block Copolymers, Di, Tri-Block Copolymers; Block Copolymers Of Polyethylene Glycol and Polypropylene Glycol, Poloxamers, Polysorbates, Alkyl Polysaccharides such as Alkyl Polyglycosidesand Blends thereof, Amine Ethoxylates, Sorbitan Fatty Acid Ester, Glycol and Glycerol Esters, Glucosidyl Alkyl Ethers, Sodium Tallowate, Polyoxyethylene Glycol, Sorbitan Alkyl Esters, Sorbitan Derivatives, Fatty Acid Esters of Sorbitan (Spans) and Their Ethoxylated Derivatives (Tweens), and Sucrose Esters of Fatty Acids, Cocamide Diethanolamine (DEA), Cocamide Monoethanolamine (MEA), Decyl Glucoside, Decylpolyglucose, Glycerol Monostearate, Lauryl Glucoside, Maltosides, Monolaurin, Narrow-Range Ethoxylate, Nonidet P-40, Nonoxynol-9, Nonoxynols, Octaethylene Glycol Monododecyl Ether, N-Octyl Beta-D-Thioglucopyranoside, Octyl Glucoside, Oleyl Alcohol, PEG-10 Sunflower Glycerides, Pentaethylene Glycol Monododecyl Ether, Polidocanol, Poloxamer, Poloxamer 407, Polyethoxylated Tallow Amine, Polyglycerol Polyricinoleate, Polysorbate, Polysorbate 20, Polysorbate 80, Sorbitan, Sorbitanmonolaurate, Sorbitanmonostearate, Sorbitantristearate, Stearyl Alcohol, Surfactin, Glyceryl Laureate, Lauryl Glucoside, Nonylphenolpolyethoxyethanols, Nonyl Phenol Polyglycol Ether, Castor Oil Ethoxylate, Polyglycol Ethers, Polyadducts of Ethylene Oxide and Propylene Oxide, Block Copolymer of Polyalkylene Glycol Ether and Hydroxystearic Acid, Tributylphenoxypolyethoxy Ethanol, Octylphenoxypolyethoxy Ethanol, Etho-Propoxylatedtristyrlphenols, Ethoxylated Alcohols, Polyoxy Ethylene Sorbitan, Fatty Acid Polyglyceride, a Fatty Acid Alcohol Polyglycol Ether, Acetylene Glycol, Acetylene Alcohol, an Oxyalkylene Block Polymer, Polyoxyethylene Alkyl Ether, Polyoxyethylenealkylaryl Ether, a Polyoxyethylenestyrylaryl Ether, a gum arabic, gum karaya, gum ghatti (gum dhawada), larch gum, welan gum, Albizia gum, Abelmoschus gum, Bhara gum, Cashew gum, Cordio gum, Grewia gum, Hakea gum, Khaya gum, Katira gum, Kondagogu gum, Leucaena, seed gum, Malva nut gum, Mucuna gum, Moringa gum, Neem gum, Sesbanic gum, Polyoxyethylene Glycol Alkyl Ether, Polyethylene Glycol, a Polyoxyethylene Fatty Acid Ester, a Polyoxyethylenesorbitan Fatty Acid Ester, a Polyoxyethyleneglycerin Fatty Acid Ester, Alcohol Ethoxylates—C6 to C16/18 Alcohols, Linear and Branched, Alcohol Alkoxylates—Various Hydrophobes and EO/PO Contents and Ratios, Fatty Acid Esters-Mono and Diesters, Lauric, Stearic and Oleic, Glycerol Esters—with and without EO, Lauric, Stearic, Cocoa and Tall Oil Derived, Ethoxylated Glycerine, Sorbitan Esters—with and without EO; Lauric, Stearic and Oleic Based, Mono and Trimesters, Castor Oil Ethoxylates-5 to 200 Moles EO, Non-Hydrogenated and Hydrogenated, Block Polymers, Amine Oxides-Ethoxylated and Non-Ethoxylated; Alkyl Dimethyl, Fatty Amine Ethoxylates-Coco, Tallow, Stearyl, Oleyl Amines, a Polyoxyethylene Hydrogenated Castor Oil or a Polyoxypropylene Fatty Acid Ester, salts or derivatives thereof.

Amphoteric or Zwitterionic surfactants include one or more of but not limited to one or more of Betaine, Coco and Lauryl Amidopropyl Betaines, Coco Alkyl Dimethyl Amine Oxides, Alkyl Dimethyl Betaines, C8 to C18, Alkyl Dipropionates-Sodium Lauriminodipropionate, Cocoamidopropyl Hydroxyl Sulfobetaine, Imidazolines, Phospholipids Phosphatidylserine, Phosphatidylethanolamine, Phosphatidylcholine and Sphingomyelins, Lauryl Dimethylamine Oxide, Alkyl Amphoacetates and Proprionates, Alkyl Ampho(Di)Acetates and Di-Proprionates, Lecithin and Ethanolamine Fatty Amides, salts or derivatives thereof.

Surfactants that are commercially available under the trademark but are not limited to one or more of Atlas G5000, TERMUL 5429, TERMUL 2510, ECOTERIC®, EULSOGEN® 118, Genapol®X, Genapol®OX-080, Genapol® C 100, Emulsogen® EL 200, Arlacel P135, Hypermer 8261, Hypermer B 239, Hypermer B261, Hypermer B246sf, Solutol HS 15, Promulgen™ D, Soprophor 7961P, Soprophor TSP/461, Soprophor TSP/724, Croduret 40, Etocas 200, Etocas 29, Rokacet R26, Cetomacrogol 1000, CHEMONIC OE-20, Triton N-101, Triton X-100, Tween 20, 40, 60, 65, 80, Span20, 40, 60, 80, 83, 85, 120, Brij®, Atlox 4912, Atlas G5000, TERMUL 3512, TERMUL 3015, ECOTERIC® T85, ECOTERIC® T20, TERIC 12A4, IGEPAL CA-630 and Isoceteth-20.

However, those skilled in the art will appreciate that it is possible to utilize other conventionally known surfactants without departing from the scope of the present invention. The surfactants are commercially manufactured and available through various companies.

According to an embodiment, the surfactant is present in an amount of 0.1% to 40% w/w of the total composition. According to an embodiment, the surfactant is present in an amount of 0.1% to 30% w/w of the total composition. According to further embodiment, the surfactant is present in an amount of 0.1% to 20% w/w of the total composition. According to further embodiment, the surfactant is present in an amount of 0.1% to 10% w/w of the total composition.

According to an embodiment, the dispersing agents which are used in the crop nutrition composition includes, but not limited to one or more of polyvinyl pyrrolidone, polyvinyl alcohol, lignin sulphonates, phenol naphthalene sulphonates, alkali metal, alkaline earth metal and ammonium salts of lignosulfonic acid, lignin derivatives, dibutylnaphthalene-sulfonic acid, alkylarylsulfonates, alkyl sulfates, alkylsulfonates, fatty alcohol sulfates, fatty acids and sulfated fatty alcohol glycol ethers, polyoxyethylene alkyl ethers, dioctyl sulfosuccinate, lauryl sulfate, polyoxyethylene alkyl ether sulphate, polyoxyethylenestyryl phenyl ether sulfate ester salts and the like, alkali metal salts thereof, ammonium salts or amine salts, polyoxyethylene alkyl phenyl ether, polyoxyethylenestyryl phenyl ether, polyoxyethylene alkyl esters, or polyoxyethylenesorbitan alkyl esters, and the like, mixture of sodium salt of naphthalene sulphonic acid urea formaldehyde condensate and sodium salt of phenol sulphonic formaldehyde condensate ethoxylated alkyl phenols, ethoxylated fatty acids, alkoxylated linear alcohols, polyaromatic sulfonates, sodium alkyl aryl sulfonates, glyceryl esters, ammonium salts of maleic anhydride copolymers, maleic anhydride copolymers, phosphate esters, condensation products of aryl sulphonic acids and formaldehyde, addition products of ethylene oxide and fatty acid esters, salts of addition products of ethylene oxide and fatty acid esters, sodium salt of isodecylsulfosuccinic acid half ester, polycarboxylates, sodium alkyl benzene sulfonates, sodium salts of sulfonated naphthalene, ammonium salts of sulfonated naphthalene, salts of polyacrylic acids, sodium salts of condensed phenolsulfonic acid as well as the naphthalene sulfonate-formaldehyde condensates, sodium naphthalene sulfonate formaldehyde condensates, tristyrylphenolethoxylate phosphate esters, aliphatic alcohol ethoxylates, alkyl fatty acids, alkoxylated linear alcohols, polyaromatic sulfonates, sodium alkyl aryl sulfonates, glyceryl esters, ammonium salts of maleic anhydride copolymers, maleic anhydride copolymers, phosphate esters, condensation products of aryl sulphonic acids and formaldehyde, addition products of ethylene oxide and fatty acid esters, salts of addition products of ethylene oxide and fatty acid esters, sodium salt of isodecylsulfosuccinic acid half ester, polycarboxylates, sodium alkyl benzene sulfonates, sodium salts of sulfonated naphthalene, ammonium salts of sulfonated naphthalene, salts of polyacrylic acids, sodium salts of condensed phenolsulfonic acid as well as the naphthalene sulfonate formaldehyde condensates, sodium naphthalene sulfonate formaldehyde condensates, tristyrylphenolethoxylate phosphate esters, aliphatic alcohol ethoxylates, alkyl ethoxylates, EO-PO block copolymers, graft copolymers, ammonium salts of sulfonated naphthalene, salts of polyacrylic acids, salts or derivatives thereof.

Commercially available dispersing agents include “Morwet D425” (sodium naphthalene formaldehyde condensate ex Nouryon, USA), “Morwet EFW” Sulfated Alkyl Carboxylate and Alkyl Naphthalene Sulfonate—Sodium Salt, “Tamol PP” (sodium salt of a phenolsulphonic acid condensate), “Reax 80N” (sodium lignosulphonate), “Wettol D1” sodium alkylnaphthalene sulphonate (ex BASF). However, those skilled in the art will appreciate that it is possible to utilize other conventionally known dispersants without departing from the scope of the present invention. The dispersing agents are commercially manufactured and available through various companies.

According to an embodiment, the dispersing agent is present in an amount of 0.1%-40% w/w of the total composition. According to an embodiment, the dispersing agent is present in an amount of 0.1%-30% w/w of the total composition. According to an embodiment, the dispersing agent is present in an amount of 0.1%-20% w/w of the total composition.

According to an embodiment, the hydrocolloid which are used in the present invention includes water-binding colloids of natural origin including botanical, animal or microbial origin. The hydrocolloid used in the organic agricultural composition comprises one or more of anionic, cationic, non-ionic, amphoteric or hydrophobic hydrocolloid. According to an embodiment the hydrocolloids comprises one or more of gum arabic, gum karaya, gum ghatti (gum dhawada), larch gum, welan gum, Albizia gum, Abelmoschus gum, Bhara gum, Cashew gum, Cordio gum, Grewia gum, Hakea gum, Khaya gum, Katira gum, Kondagogu gum, Leucaena, seed gum, Malva nut gum, Mucuna gum, Moringa gum, Neem gum, Sesbanic gum, or mixtures thereof. Preferably, the hydrocolloid is anionic hydrocolloid selected from gum arabic, gum karaya, gum ghatti, neem gum and moringa gum. However, the above list of hydrocolloids is exemplary and not meant to limit the scope of the invention.

According to an embodiment, the hydrocolloid is present in an amount of 0.1%-40% w/w of the total composition. According to an embodiment, the hydrocolloid is present in an amount of 0.1%-30% w/w of the total composition. According to an embodiment, the hydrocolloid is present in an amount of 0.1%-20% w/w of the total composition.

According to an embodiment, the wetting agents used in the crop nutrition composition include, but not limited to one or more of phenol naphthalene sulphonates, alkyl naphthalene sulfonate, sodium alkyl naphthalene sulfonate, naphthalene sulphonate sodium salt, sodium salt of sulfonated alkylcarboxylate, polyoxyalkylated ethyl phenols, polyoxyethoxylated fatty alcohols, polyoxyethoxylated fatty amines, lignin derivatives, alkane sulfonates, alkylbenzene sulfonates, salts of polycarboxylic acids, salts of esters of sulfosuccinic acid, alkylpolyglycol ether sulfonates, alkyl ether phosphates, alkyl ether sulphates and alkyl sulfosuccinic monoesters, salts or derivatives thereof. However, those skilled in the art will appreciate that it is possible to utilize other conventionally known wetting agents without departing from the scope of the present invention. The wetting agents are commercially manufactured and available through various companies.

According to an embodiment, the wetting agent is present in an amount of 0.1%-30% w/w of the total composition. According to an embodiment, the wetting agent is present in an amount of 0.1%-20% w/w of the total composition. According to an embodiment, the wetting agent is present in an amount of 0.1%-10% w/w of the total composition.

Emulsifiers which are used in the crop nutrition composition include but are not limited one or more of Atlas G5000, TERMUL 5429, TERMUL 2510, ECOTERIC®, EMULSOGEN® 118, Genapol®X, Genapol®OX-080, Genapol® C 100, Emulsogen® EL 200, Arlacel P135, Hypermer 8261, Hypermer B239, Hypermer B261, Hypermer B246sf, Solutol HS 15, Promulgen™ D, Soprophor 7961P, Soprophor TSP/461, Soprophor TSP/724, Croduret 40, Etocas 200, Etocas 29, Rokacet R26, CHEMONIC OE-20, Triton™ N-101, T ween 20, 40, 60, 65, 80, Span20, 40, 60, 80, 83, 85, 120, Brij®, Triton™, Atlox 4912, TERMUL 3512, TERMUL 3015, TERMUL 5429, TERMUL 2510, ECOTERIC® T85, ECOTERIC® T20, TERIC 12A4. However, those skilled in the art will appreciate that it is possible to utilize other conventionally known emulsifiers without departing from the scope of the present invention. The emulsifiers are commercially manufactured and available through various companies.

According to an embodiment, the emulsifier is present in an amount of 0.1%-40% w/w of the total composition. According to an embodiment, the emulsifier is present in an amount of 0.1%-30% w/w of the total composition. According to an embodiment, the emulsifier is present in an amount of 0.1%-20% w/w of the total composition.

According to an embodiment, the disintegrating agents which are used in the crop nutrition composition include, but not limited to one or more of inorganic water soluble salts e.g. sodium chloride, nitrate salts; water soluble organic compounds such as hydroxypropyl starch, carboxymethyl starch ether, microcrystalline cellulose, cross-linked sodium carboxymethyl cellulose, carboxymethyl cellulose calcium, sodium tripolyphosphate, sodium hexametaphosphate, a cellulose powder, dextrin, methacrylate copolymer, Polyplasdone® XL-10 (crosslinked polyvinylpyrrolidone), sulfonated styrene-isobutylene-maleic anhydride copolymer, salts of polyacrylates of methacrylates, starch-polyacrylonitrile graft copolymer, sodium or potassium bicarbonates/carbonates or their mixtures or salts with acids such as citric and fumaric acid or salts, derivatives thereof. However, those skilled in the art will appreciate that it is possible to utilize different disintegrating agents without departing from the scope of the present invention. The disintegrating agents are commercially manufactured and available through various companies.

According to an embodiment, the disintegrating agent is present in an amount of 0.1% to 20% w/w of the composition. According to an embodiment, the disintegrating agent is present in an amount of 0.1% to 10% w/w of the composition. According to an embodiment, the disintegrating agent is present in an amount of 0.1% to 5% w/w of the composition.

According to an embodiment, the binding agents or binders which are used in the crop nutrition composition include, but not limited to one or more of carbohydrates such as monosaccharides, disaccharides, oligosaccharides and polysaccharides, complex organic substance, lignin sulfonates, polyvinylpyrrolidone, synthetic organic polymers or derivatives thereof. However, those skilled in the art will appreciate that it is possible to utilize different binding agents without departing from the scope of the present invention. The binding agents are commercially manufactured and available through various companies.

According to further embodiment, the binding agent is present in an amount of 0.1% to 30% w/w of the composition. According to further embodiment, the binding agent is present in an amount of 0.1% to 20% w/w of the composition. According to further embodiment, the binding agent is present in an amount of 0.1% to 10% w/w of the composition.

According to an embodiment, the carriers which are used in the crop nutrition composition include, but are not limited to one or more of solid carriers or fillers or diluents. According to another embodiment, the carriers include mineral carriers, plant carriers, synthetic carriers, water-soluble carriers. However, those skilled in the art will appreciate that it is possible to utilize different carriers without departing from the scope of the present invention. The carriers are commercially manufactured and available through various companies.

The solid carriers include natural minerals like clay such as china clay, acid clay, kaolin such as kaolinite, dickite, nacrite, and halloysite, serpentines such as chrysotile, lizardite, antigorite, amesite, synthetic and diatomaceous silicas, montmorillonite minerals such as sodium montmorillonite, smectites, such as saponite, hectorite, sauconite, hyderite, micas, such as pyrophyllite, talc, agalmatolite, muscovite, phengite, sericite, and illite, silicas such as cristobalite and quartz, such as attapulgite and sepiolite, vermiculite, laponite, pumice, bauxite, hydrated aluminas, perlite, sodium bicarbonate, volclay, limestone, natural and synthetic silicates, charcoal, silicas, wet process silicas, dry process silicas, calcined products of wet process silicas, surface-modified silicas, mica, zeolite, diatomaceous earth, derivatives thereof, chalks (Omya®), fuller's earth, loess, mirabilite, white carbon, slaked lime, synthetic silicic acid, starch, modified starch (Pineflow, available from Matsutani Chemical industry Co., Ltd.), cellulose, plant carriers such as cellulose, chaff, wheat flour, wood flour, starch, rice bran, wheat bran, and soyabean flour, casein sodium, sucrose, salt cake, potassium pyrophosphate, sodium tripolyphosphate or derivatives or mixtures thereof. Commercially available Silicates are A erosil brands, Sipernat brands as Sipernat® 50S and CALFLO E and kaolin 1777. However, those skilled in the art will appreciate that it is possible to utilize different solid carriers without departing from the scope of the present invention. The solid carriers are commercially manufactured and available through various companies.

According to an embodiment, the carrier is present in an amount of 0.1% to 94% w/w of the composition. According to further embodiment, the carrier is present in an amount of 0.1% to 80% w/w of the composition. According to further embodiment, the carrier is present in an amount of 0.1% to 60% w/w of the composition. According to further embodiment, the carrier is present in an amount of 0.1% to 40% w/w of the composition. According to further embodiment, the carrier is present in an amount of 0.1% to 20% w/w of the composition.

According to an embodiment, the antifoaming agents or defoamers which are used in the crop nutrition composition include but not limited to one or more of silica, siloxane, silicone dioxide, polydimethyl siloxane, alkyl polyacrylates, ethylene oxide/propylene oxide copolymers, polyethylene glycol, silicone oils and magnesium stearate or derivatives thereof. Preferred antifoaming agents include silicone emulsions (such as, e.g., Silikon® SRE, Wacker or Rhodorsil® from Rhodia), long-chain alcohols, fatty acids, fluoro-organic compounds. However, those skilled in the art will appreciate that it is possible to utilize other conventionally known antifoaming agents without departing from the scope of the present invention. The antifoaming agents are commercially manufactured and available through various companies.

According to an embodiment, the anti-foaming agent is present in an amount of 0.01% to 20% w/w of the total composition.

According to an embodiment, the pH-adjusters or buffers or neutralizing agents which are used in the composition include both acids and bases of the organic or inorganic type and mixtures thereof. According to further embodiment, pH-adjusters or buffers or neutralizing agents include but not limited to one or more of organic acids, inorganic acids and alkali metal compounds or salts, derivatives thereof. According to an embodiment, the organic acids include but not limited to one or more of citric, malic, adipic, fumaric, maleic, succinic, and tartaric acid, or salts, derivatives thereof, and the mono-, di-, or tribasic salts of these acids or derivatives thereof. Alkali metal compounds include but not limited to one or more of hydroxides of alkali metals such as sodium hydroxide and potassium hydroxide, carbonates of alkali metals such as sodium carbonate, hydrogen carbonates of alkali metals such as sodium hydrogen carbonate and alkali metal phosphates such as sodium phosphate and mixtures thereof. According to an embodiment, the salts of inorganic acids include but not limited to one or more of alkali metal salts such as, sodium chloride, potassium chloride, sodium nitrate, potassium nitrate, sodium sulfate, potassium sulfate, sodium monohydrogen phosphate, potassium monohydrogen phosphate, sodium dihydrogen phosphate, potassium dihydrogen phosphate and the like. Mixtures can also be used to create a pH-adjusters or buffers or neutralizing agents. However, those skilled in the art will appreciate that it is possible to utilize other conventionally known pH-adjusters or buffers or neutralizing agents without departing from the scope of the present invention. The pH-adjusters or buffers or neutralizing agents are commercially manufactured and available through various companies.

According to an embodiment, the pH-adjusters or buffers are present in an amount of 0.01% to 20% w/w of the total composition. According to an embodiment, the pH-adjusters or buffers are present in an amount of 0.01% to 10% w/w of the total composition. According to an embodiment, the pH-adjusters or buffers are present in an amount of 0.01% to 5% w/w of the total composition. According to an embodiment, the pH-adjusters or buffers are present in an amount of 0.01% to 1% w/w of the total composition.

According to an embodiment, the spreading agents which are used in the composition include but not limited to one or more of a copolymer of maleic acid with a styrene compound, a (meth)acrylic acid copolymer, a half ester of a polymer consisting of polyhydric alcohol with dicarboxylic anhydride, a water-soluble salt of polystyrene sulfonic acid, fatty acids, latex, aliphatic alcohols, vegetable oils such as cottonseed, inorganic oils, petroleum distillates, modified trisiloxanes, polyglycol or salts or derivatives thereof. However, those skilled in the art will appreciate that it is possible to utilize other conventionally known spreading agents without departing from the scope of the present invention. The spreading agents are commercially manufactured and available through various companies.

According to an embodiment, the spreading agent is present in an amount of 0.01% to 20% w/w of the total composition. According to an embodiment, the spreading agent is present in an amount of 0.01% to 5% w/w of the total composition.

According to an embodiment, the sticking agents which are used in the composition include but not limited to one or more of paraffin, a polyamide resin, polyacrylate, polyoxyethylene, wax, polyvinyl alkyl ether, an alkylphenol-formalin condensate, fatty acids, latex, polyvinyl pyrrolidone, aliphatic alcohols, gums such as xanthan gum, gum ghati, gum arabic etc, vegetable oils such as cottonseed, or inorganic oils, petroleum distillates, modified trisiloxanes, polyglycol, a synthetic resin emulsion, salts or derivatives thereof. However, those skilled in the art will appreciate that it is possible to utilize other conventionally known sticking agents without departing from the scope of the present invention. The sticking agents are commercially manufactured and available through various companies.

According to an embodiment, the sticking agent is present in an amount of 0.01% to 30% w/w of the total composition. According to an embodiment, the sticking agent is present in an amount of 0.01% to 15% w/w of the total composition.

The inventors have further determined that the composition of the present invention surprisingly has enhanced physical properties of dispersibility, suspensibility, wetting time, provides ease of handling and also reduces the loss of material while handling the product at the time of packaging as well as during field application.

Wettability is the condition or the state of being wettable and can be defined as the degree to which a solid is wetted by a liquid, measured by the force of adhesion between the solid and liquid phases. The wettability of the granular composition is measured using the Standard CIPAC Test MT-53 which describes a procedure for the determination of the time of complete wetting of wettable formulations. A weighed amount of the granular composition is dropped on water in a beaker from a specified height and the time for complete wetting was determined.

According to an embodiment, the composition of the present invention has wettability of less than 2 minutes. According to an embodiment, the composition has wettability of less than 1 minute. According to an embodiment, the composition has wettability of less than 30 seconds.

Dispersibility of the water dispersible granular composition of the present application is determined as per the standard CIPA C test, MT 174. According to an embodiment, the water dispersible granular composition has a dispersibility of at least 30%. According to an embodiment, the water dispersible granular composition has a dispersibility of at least 40%. According to an embodiment, the water dispersible granular composition has a dispersibility of at least 50%. According to an embodiment, the water dispersible granular composition has can dispersibility of at least 60%. According to an embodiment, the water dispersible granular composition has a dispersibility of at least 70%. According to an embodiment, the water dispersible granular composition has a dispersibility of at least 80%. According to an embodiment, the water dispersible granular composition has a dispersibility of at least 90%. According to an embodiment, the water dispersible granular composition has a dispersibility of at least 99%. According to an embodiment, the water dispersible granular composition has a dispersibility of 100%. The composition of the present invention disperses uniformly into finer particles in the size range of 0.1 micron to 30 microns when comes in contact with water.

According to an embodiment, the crop nutrition composition in the form of water dispersible granules exhibits almost instantaneous dispersion thus making the actives readily available to the crops.

Suspensibility is defined as the amount of active ingredient suspended after a given time in a column of liquid of stated height, expressed as a percentage of the amount of active ingredient in the original suspension. The test for suspensibility is done as per the CIPAC Handbook, “MT 184 Test for Suspensibility”.

According to an embodiment, the composition of the present invention has a suspensibility of at least 30%. According to an embodiment, the composition has a suspensibility of at least 40%. According to an embodiment, the composition has a suspensibility of at least 50%. According to an embodiment, the composition has a suspensibility of at least 60%. According to an embodiment, the composition has a suspensibility of at least 70%. According to an embodiment, the composition has a suspensibility of at least 80%. According to an embodiment, the composition has a suspensibility of at least 90%. According to an embodiment, the composition has a suspensibility of at least 99%. According to an embodiment, the pesticidal composition has a suspensibility of 100%.

According to an embodiment, the composition of the present invention demonstrates superior suspensibility under accelerated storage condition (ATS). According to an embodiment, the composition demonstrates a suspensibility of more than 90% under ATS. According to an embodiment, the composition demonstrates a suspensibility of more than 80% under ATS. According to an embodiment, the composition demonstrates a suspensibility of more than 70% under ATS. According to an embodiment, the composition demonstrates a suspensibility of more than 60% under ATS. According to an embodiment, the composition demonstrates a suspensibility of more than 50% under ATS. According to an embodiment, the composition demonstrates a suspensibility of more than 40% under ATS. According to an embodiment, the composition demonstrates a suspensibility of more than 30% under ATS.

According to an embodiment, the composition of the present invention demonstrates a dispersibility of more than 90% under ATS. According to an embodiment, the composition demonstrates a dispersibility of more than 80% under ATS. According to an embodiment, the composition demonstrates a dispersibility of more than 70% under ATS. According to an embodiment, the composition demonstrates a dispersibility of more than 60% under ATS. According to an embodiment, the composition demonstrates a dispersibility of more than 50% under ATS. According to an embodiment, the composition demonstrates a dispersibility of more than 40% under ATS. According to an embodiment, the composition demonstrates a dispersibility of more than 30% under ATS.

According to an embodiment, the present invention relates to a process for preparing a crop nutrition composition in the form of water dispersible granules comprising a homogeneous mixture of an effective amount of one or more of water insoluble Magnesium salt, complex or derivatives thereof and an effective amount of one or more of water insoluble Zinc salt, complex or derivatives thereof with at least one agrochemically acceptable excipient.

According to further embodiment, the invention relates to a process for preparing a crop nutrition composition in the form of water dispersible granular composition comprising a homogeneous mixture of one or more of water insoluble Magnesium salt, complex or derivatives thereof in the range of 5%-80% w/w of the total composition and one or more of water insoluble Zinc salt, complex or derivatives thereof in the range of 1%-50% w/w of the total composition with at least one agrochemically acceptable excipient; wherein the granules of the composition comprises particles in the size range of 0.1 micron-30 microns.

The crop nutrition composition in the form of water dispersible granules is made by various techniques such as spray drying, fluidized bed granulation, extrusion, freeze drying, spheronization etc.

According to an embodiment, the process for preparing a water dispersible granular composition involves milling a homogeneous blend of one or more of water insoluble Zinc salt, complex or derivatives thereof and one or more water insoluble Magnesium salt, complex or derivatives thereof with at least one agrochemically acceptable excipient; to obtain slurry or a wet mix in water. The slurry obtained is then dried for instance in a spray dryer, fluid bed dryer or any suitable granulating equipment to obtain water dispersible granules comprising particles in the size range of 0.1 micron-30 microns. The water dispersible granules are further sieved to remove the under sized and oversized granules and obtain a desired size.

According to another embodiment, the crop nutrition composition in the form of water dispersible granules is also made by dry milling a homogeneous blend of one or more of water insoluble Zinc salt, complex or derivatives thereof and one or more water insoluble Magnesium salt, complex or derivatives thereof with at least one agrochemically acceptable excipient in an air mill or a jet mill to obtain a homogeneous mixture with fine particle size. Water is added to the dry powder and the mixture is blended to obtain a dough or paste or wet mix, which is then extruded through an extruder to obtain the granules comprising particles in the size range of 0.1 micron-30 microns. The water dispersible granules are further sieved to remove the under sized and oversized granules and obtain a desired size.

According to an embodiment, the invention further relates to the use of the crop nutrition composition as at least one of a nutrient composition, a crop strengthener composition, a soil conditioner composition, crop protection and a yield enhancer composition.

According to an embodiment, the invention further relates to a method for improving plant health or enhancing the uptake of nutrient by the plants or plant yield wherein the method comprises treating at least one of a plant, a plant propagation material, locus or plant parts, a seed, seedling; or surrounding soil with the water dispersible granular composition of the present invention.

According to an embodiment, the invention also relates to a method of application of an effective amount of the crop nutrition composition in the form of water dispersible granules comprising a homogeneous mixture of 5% to 80% by weight of one or more water insoluble Magnesium salt, complex or derivative thereof, 1% to 50% by weight of one or more water insoluble Zinc salt, complex or derivatives thereof and 0.01%-94% by weight of agrochemically acceptable excipient, wherein the elemental Zinc is present in the range of 0.01% to 50% by weight of the total composition and wherein the elemental Magnesium is present in the range of 0.1% to 50% by weight of the total composition and wherein the granules of the composition comprises particles in the size range of 0.1 micron-30 microns and wherein the composition is applied to the seeds, seedlings, crops, a plant, plant propagation material, locus, plants parts or to the surrounding soil.

The present invention further provides balanced uptake of all nutrients, improves the crop health, improves the crop nutrition by facilitating the uptake of essential nutrients, protects the crop, enhances the crop yield, strengthens the plant or assists in conditioning the soil.

The present composition can be applied through a variety of methods. Methods of applying to the soil includes any suitable method which ensures that the composition penetrates the soil for example nursery tray application, in furrow application, drip irrigation, sprinkler irrigation, soil drenching, soil injection or incorporation into the soil and such other methods. The composition also can be applied in the form of a foliar spray.

The rates of application or the dosage of the composition depends on the type of use, the type of crops, or the specific active ingredients in the composition but is such that the active ingredient, is in an effective amount to provide the desired action such as crop protection, crop yield and nutrient uptake.

### A. PREPARATION EXAMPLES

The following examples illustrate the basic methodology and versatility of the composition of the invention. The water insoluble sources of Magnesium and Zinc exemplified in the preparatory examples can be replaced by any other water insoluble salts, complexes or derivatives thereof of these nutrients as covered in the present invention varying the claimed concentration ranges respectively. It should be noted that this invention is not limited to these exemplifications.

### Water Dispersible Granular Composition of Magnesium Salt and Zinc Salt:

1. Water dispersible granular composition of 25% Zinc Carbonate (elemental Zinc 13%), 35% Magnesium Oxide (elemental Magnesium 21.11%).
   Water dispersible granular composition was prepared by blending or mixing 25 part of Zinc Carbonate and 35 parts of Magnesium Oxide, 14 parts of Naphthalene Sulphonate Condensate, 8 parts of polycarboxylate, 8 parts of Sodium Lignosulfonate, 5 parts of Kaolin and 5 parts of Sodium sulphate to obtain a blend. The blend obtained was milled to get a powder of less than 15 micron size. The powder was mixed with water in a suitable mixing equipment to form a slurry.
   The slurry obtained was wet ground in suitable wet grinding equipment. The wet milled slurry obtained was spray dried at an inlet temperature less than 175° C. and outlet temperature less than 90° C. to get granules. The composition has particle size distribution D50 less than 7.5 microns. The granule size of the composition is in the range of 0.1-1.5 mm. The composition has a dispersibility of 70%, suspensibility of 65% and wettability of less than 25 sec. The composition further demonstrated suspensibility of about 60% and dispersibility of 65%, wettability of 30 seconds under accelerated storage condition.
2. Water dispersible granular composition of 5% Zinc Carbonate (elemental Zinc 2.6%), 80% Magnesium Silicate (elemental Magnesium 13.9%).
   The water dispersible composition is prepared as per Example 1 by blending 80 parts of Magnesium Silicate, 5 parts of Zinc Carbonate, 5 parts Neem gum, 3 parts of Naphthalene Sulphonate Condensate Sodium Salt, 3 parts of china clay and 4 parts of Lactose. The composition has particle size distribution D50 less than 8.5 microns. The granule size of the composition is in the range of 0.1-2.5 mm. The composition has a dispersibility of 71%, suspensibility of 65% and wettability of less than 15 sec. The composition further demonstrated suspensibility of about 62% and dispersibility of 65%, wettability of 25 seconds under accelerated storage condition.
3. Water dispersible granular composition of 15% Zinc Silicate (elemental Zinc 8.8%) and 45% Magnesium Silicate (elemental Zinc 7.8%).
   The water dispersible composition is prepared as per Example 1 by mixing 45 parts of Magnesium Silicate, 15 parts of Zinc Silicate, 12 parts of Polyacrylate Sodium, 18 parts of Naphthalene Sulphonate Condensate Sodium Salt, 6 parts of Larch gum and 3 parts of Stepsperse DF200 and 1 part of Sodium Citrate. The composition has particle size distribution D50 less than 10 microns. The granule size of the composition9 is in the range of 0.1-1.5 mm. The composition has a dispersibility of 90%, suspensibility of 85%, and wettability of less than 10 sec. The composition further demonstrated suspensibility of about 80% and dispersibility of 90%, wettability of 15 seconds under accelerated storage condition.
4. Water dispersible granular composition of 40% Zinc Oxide (elemental Zinc 32.1%) and 25% Magnesium Carbonate (elemental Magnesium 7.2%).
   The water dispersible composition is prepared as per Example 1 by blending 25 parts of Magnesium Carbonate, 40 parts of Zinc Oxide, 3 parts of tristryl phenol ethoxylate phosphate ester, 11 parts of sodium lignosulphonate, 6 parts of polycarboxylate, 5 parts of Larch Gum, 8 parts of Stepsperse D F200 and 2 part of calcium chloride. The composition has particle size distribution D50 less than 14 microns. The granule size of the composition is in the range of 0.1-2.5 mm. The composition has a dispersibility of 40%, suspensibility of 40% and wettability of less than 35 sec. The composition further demonstrated suspensibility of about 38% and dispersibility of 35%, wettability of 40 seconds under accelerated storage condition.
5. Water dispersible granular composition of 3% Zinc B orate (elemental Zinc 1.875) and 75% Magnesium Phosphate (elemental Magnesium 20.7%).
   The water dispersible composition is prepared as per extrusion process by blending 3 parts of Zinc Borate, 75 parts of Magnesium Phosphate, 4 parts of Naphthalene Sulphonate Condensate Sodium Salt lignin sulphonate calcium, 6 parts of polycarboxylate, 4 parts of Larch Gum, 6 parts of Stepserse and 2 part of Sodium Citrate. The composition has particle size distribution D50 less than 20 microns. The granule size of the composition is in the range of 0.1-3.5 mm. The composition has a dispersibility of 40%, suspensibility of 40% and wettability of less than 35 sec. The composition further demonstrated suspensibility of about 38% and dispersibility of 35%, wettability of 40 seconds under accelerated storage condition.

### B. FIELD STUDY

### Experiment 1: To Study the Effect of Water Dispersible Granules of “Water Insoluble Magnesium Salt and Water Insoluble Zinc Salt” on Groundnut Crop

Field trial was conducted for the evaluation of an embodiment of the composition of the present invention at Nashik, Maharashtra on Groundnut crop, variety J L 776. The trials were laid down in Randomized Block Design (RBD) with seven treatments including untreated control, replicated three times. For each treatment, plot size of 35 sq.m (7 m×5 m) was maintained. The test nutritional compositions with various Zinc salts, Magnesium salts alone and their combination in water dispersible granules varying concentration range and salts with prescribed dose were applied as basal application at the time of sowing of Groundnut crop. The active dosage of Zinc and Magnesium applied in the field experiment is of elemental Zinc (Zn) and elemental Magnesium (Mg).

The details of the experiment are as follows:

a) Trial Location: Nashik, Maharashtra
b) Crop: Groundnut (JL776)
c) Experiment season: Rabi 2022
d) Trial Design: Randomized Block Design
e) Replications: Three
f) Treatment: seven
g) Plot size: 7 m × 5 m = 35 sq · m
h) Date of Application: 3 Feb. 2022
i) Date of sowing: 3 Feb. 2022
j) Method of application: Basal
k) Date of Harvesting: 15 May 2022
l) Soil pH: 7.2

The observations were recorded at the harvesting time and the mean data were presented in Table 1 to enumerate the efficacy of the water dispersible granules of “water insoluble Magnesium salt and water insoluble Zinc salt” prepared as per the embodiment of the present invention.

TABLE 1

| | | | | | | Nutrient | | | |
|---|---|---|---|---|---|---|---|---|---|
| | | | | | | concentration | | Number | |
| | Active | | Yield | | Expected | (mg/100 Kg | | of | Mean Plant |
| | ingredient gm/ha | | (Kg/ | % Increase | yield | of seeds) | | pods/ | Height (cm) |
| Treatment Details | Zinc | Magnesium | ha) | in Yield | increase | Zn | Mg | plant | 30DAA |
| T1: 15% Zinc Carbonate | 289.41 | 373.40 | 1205 | 54.49 | 31.26 | 2.7 | 135 | 15.5 | 38.00 |
| (elemental Zinc 7.8%) + | | | | | (1.74*) | | | | |
| 35% Magnesium Carbonate | | | | | | | | | |
| (elemental Magnesium 10%) | | | | | | | | | |
| WDG@3700 gm/ha as per | | | | | | | | | |
| embodiment of the present | | | | | | | | | |
| invention | | | | | | | | | |
| T2: 15% Zinc Carbonate | 289.4 | 0 | 945 | 21.15 | | 1.5 | 88 | 13.5 | 34.00 |
| (elemental Zinc 7.8%) | | | | | | | | | |
| WDG@3700 gm/ha | | | | | | | | | |
| T3: 35% Magnesium Carbonate | 0 | 373.40 | 880 | 12.82 | | 0.3 | 90 | 12.5 | 35.00 |
| (elemental Magnesium 10%) | | | | | | | | | |
| WDG@3700 gm/ha | | | | | | | | | |
| T4: 35% Zinc Oxide | 1051 | 947 | 1180 | 51.28 | 28.41 | 2.1 | 150 | 15.4 | 40.00 |
| (elemental Zinc 28.1%) + | | | | | (1.80*) | | | | |
| 42% Magnesium Oxide | | | | | | | | | |
| (elemental Magnesium 25.33%) | | | | | | | | | |
| WDG @3740 gm/ha as per | | | | | | | | | |
| embodiment of the present | | | | | | | | | |
| invention | | | | | | | | | |
| T5: 35% Zinc oxide | 1051 | | 895 | 14.74 | | 1.1 | 87 | 13.2 | 33.00 |
| (elemental Zinc 28.1%) | | | | | | | | | |
| WDG@3740 gm/ha | | | | | | | | | |
| T6: 42% Magnesium oxide | | 947 | 905 | 16.03 | | 0.2 | 95 | 13.5 | 35.00 |
| (elemental Magnesium 25.33%) | | | | | | | | | |
| WDG@3740 gm/ha | | | | | | | | | |
| T7-Untreated | | | 780 | | | 0.1 | 85 | 12 | 32.00 |

*Synergy factor
*DAA Days after application
*The water insoluble Magnesium and Zinc salts selected and the concentration used therein is exemplary and can be replaced with other water insoluble Magnesium and Zinc salt with different concentrations as claimed in the present invention.

“Synergy” is as defined by Colby S. R. in an article entitled “Calculation of the synergistic and antagonistic responses of herbicide combinations” published in Weeds, 1967, 15, p. 20-22. The action expected for a given combination of two active components can be calculated as follows:

$$E = X + Y - ( XY ) / 100$$

$$Where ,$$

$$E = Expected \% effect by mixture of two products X , Y and Z in a defined dose .$$

$$X = Observed \% effect by product A$$

$$Y = Observed \% effect by product B$$

The synergy factor (SF) is calculated by Abbott's formula (Eq. (2) (Abbott, 1925). SF=Observed effect/Expected effect

Where, SF>1 for Synergistic reaction; SF<1 for antagonistic reaction; SF=1 for additive reaction.

When the percentage of yield effect observed (E) for the combination is greater than the expected percentage, synergistic effect of the combination can be inferred. When the percentage of yield effect observed for the combination is equal to the expected percentage, merely an additive effect may be inferred, and wherein the percentage of yield effect observed for the combination is lower than the expected percentage, an antagonistic effect of the combinations can be inferred.

From the data observed in the Table 1, it can be concluded that the compositions T1 and T4 as per the embodiments of the present invention demonstrate synergistic behavior.

It can be observed that the synergy factor is 1.74 and 1.8 for treatments T1 and T4 as per embodiment of the present invention from Table 1 depicts that the WDG compositions of “Zinc Carbonate+Magnesium Carbonate”, “Zinc Oxide+Magnesium Oxide,” are synergistic in nature. This synergistic behavior of “water insoluble Zinc salt with water insoluble Magnesium salt” in the form of WDG as per embodiment of the present invention can be observed from the yield of Groundnut kernel.

Based on the data and the calculations made, the expected percentage increase in the groundnut kernel yield was found to be 31.26% and 28.41% for treatments T1 and T4 respectively. However, it can be clearly seen from the Table 1 above, that the treatment T1 with 15% Zinc Carbonate (elemental Zinc 7.8%) and 35% Magnesium Carbonate (elemental Magnesium 10%)—water dispersible granular composition (WDG), as per the embodiment of the present invention showed a 54.49% yield increase in Groundnut kernel and Treatment T4 with 35% Zinc Oxide and 42% Magnesium Oxide-WDG composition, as per the embodiment of the present invention showed a 51.28% increase in the yield of Groundnut kernel.

However, treatments T2 with 15% Zinc Carbonate WDG, T3 with 35% Magnesium Carbonate WDG demonstrated 25.15% and 12.82% increase in the kernel yield of Groundnut crop respectively. Further treatment T5 with 35% Zinc Oxide WDG and T6 with 42% Magnesium Oxide WDG depicted yield of only 14.74% and 16.03% respectively. Thus, the treatments T1 and T4 with water dispersible granules as per the embodiments of the present invention demonstrated a synergistic effect, as compared to the treatment with individual actives. The results are all the more surprising as all the treatments T2-T3 and T5-T6 had the same dosage of Zinc salt and Magnesium salt being applied to the soil i.e. 289.41 g/ha of Zinc, 373.4 g/ha of Magnesium and 1051 g/ha of Zinc, 947 g/ha of Magnesium respectively.

It can be further seen from the Table 1, that treatments T1 and T4 with compositions as per the embodiment of the present invention showed a surprising uptake of nutrients like Magnesium and Zinc as compared to treatments T2-T3 and T5-T6 where Zinc and Magnesium salts used individually even when these actives are applied at same dosages of application in each treatment. Thus, the combination of “water insoluble Magnesium salt with water insoluble Zinc salt” in the form of a water dispersible granule as per the embodiments of the present invention, is synergistic in nature and showed a surprising enhancement in the yield as well as improved plant physiological parameters like increased Plant height, number of pods per plant as compared to treatments with individual application of actives.

Thus, a composition of present invention in the form of a water dispersible granular composition was found to be high nutrient use efficient composition.

### Experiment No 2: To Study the Effect of Water Dispersible Granules of “Water Insoluble Magnesium Salt and Water Insoluble Zinc Salt” on Tomato Crop

The experimental site was selected based on tomato crops where the nutrient deficiency symptoms were likely to occur, where the soil nutrient content was below the deficit level.

The trial was laid out during Kharif season in Randomized Block Design (RBD) with seven treatments including untreated control, replicated four times. For each treatment, plot size of 40 sq. m (8 m×5 m) was maintained. The compositions evaluated include Zinc salt, Magnesium salt alone and different formulations including combinations of Zinc salt with Magnesium salt, where Zinc salt, Magnesium salt, were applied in each treatment at same dosages. The tomato crop in the trial field was raised following good agricultural practices. The seed of Tomato, Abhilash, were used for the study and planted in 120 cm row to row and 45 cm plant to plant spacing. The details of the experiment are as follows:

Details of experiment

a) Trial Location: Nasik (MH)
b) Crop: Tomato (variety Abhilash)
c) Experiment season: Kharif 2021
d) Trial Design: Randomized Block Design
e) Replications: Four
f) Treatment: Seven
g) Plot size: 8 m × 5 m = 40 sq · m
h) Date of Application: 6 Jul. 2021
i) Method of application: Bend/side placement
j) Date of transplanting: 6 Jul. 2021
k) Date of Pickings: 15 Oct. 2021, 25 Oct. 2021, 5 Nov. 2021

The observations on fruit setting were carried out by tagging newly opened blossoms once a week, and counting the number of tagged blossoms which set fruits one week later. The fruits were harvested six times and weighed each time. The mean data of all the observations were presented in Table 2 to illustrate the impact of combination of water insoluble salt of Zinc with water insoluble salt of Magnesium in water dispersible granular form as per the embodiment of the present invention on Tomato yield and other parameters.

TABLE 2

| | | | | | | Disease |
|---|---|---|---|---|---|---|
| | | | | % | | control |
| | | | Tomato | Increase | | Early |
| | Active ingredients | | Fruit | in Yield | Expected | blight |
| | (grams/hectare) | | Yield | over | Yield | Severity |
| Treatment Details | Zinc | Magnesium | (Kg/ha) | untreated | increase | (%) |
| T1-5% Zinc Carbonate | 129.97 | | 1480 | 5.71 | 16.15 | 31.4 |
| (elemental Zinc 2.6%) | | | | | (1.32*) | |
| WDG @ 4985 gm/ha | | | | | | |
| T2- 80% Mg Silicate | 0 | 693 | 1555 | 11.07 | | 25.1 |
| (elemental Magnesium | | | | | | |
| 13.9%) WDG@4985 gm/ha | | | | | | |
| T3- 5% Zinc Carbonate | 129.97 | 693 | 1700 | 21.43 | | 5 |
| (elemental Zinc 2.6%) + | | | | | | |
| 80% Magnesium | | | | | | |
| Silicate(elemental | | | | | | |
| Magnesium 13.9%) | | | | | | |
| WDG@4985 gm/ha as per | | | | | | |
| embodiment of the present | | | | | | |
| invention | | | | | | |
| T4-20% Zinc Oxide | 800.98 | | 1520 | 8.57 | 11.84 | 35.3 |
| (elemental Zinc 16%) | | | | | (1.50*) | |
| WDG@4985 gm/ha | | | | | | |
| T5- 15% Magnesium | 0 | 215.61 | 1450 | 3.57 | | 30.5 |
| Carbonate (elemental | | | | | | |
| Magnesium 4.3%) | | | | | | |
| WDG@4985 gm/ha | | | | | | |
| T6-20% Zinc oxide | 800.98 | 215.61 | 1650 | 17.8 | | 7.3 |
| (elemental Zinc 16%) + | | | | | | |
| 15% Magnesium carbonate | | | | | | |
| (elemental Magnesium 4.3%) | | | | | | |
| WDG @ 4985 gm/ha as | | | | | | |
| per embodiment of the | | | | | | |
| present invention | | | | | | |
| T7-Untreated | | | 1400 | | | 45.5 |

Synergy factor*

From the data observed in the Table 2, it can be concluded that the treatments T3 (5% Zinc Carbonate (elemental Zinc 2.6%)+80% Magnesium Silicate (elemental Magnesium 13.9%) WDG), and T6 (20% Zinc oxide (elemental Zinc 16%)+15% Magnesium carbonate (elemental Magnesium 4.3%) WDG) as per the embodiments of the present invention demonstrate synergistic behavior.

Based on the data and the calculations made, the expected percentage increase in the Tomato fruit yield was found to be 16.15% and 11.84% for treatments T3 and T6 respectively. However, for instance it can be clearly seen from the Table 2 above, that the treatment T3 with 5% Zinc Carbonate+80% Magnesium Silicate WDG as per the embodiment of the present invention showed a 21.43% yield increase in Tomato whereas treatment T1 with 5% Zinc Carbonate WDG and treatment T2 with 80% Magnesium Silicate WDG showed an increase in yield of 5.71% and 11.07% respectively. Similarly, treatments T6 as per embodiment of the present invention depicted better yield in tomato as compared to individual treatments of T4 and T5.

The table 2 also depicted mean data of ten plants wherein the Early blight disease severity was found to be minimum with treatments T3 and T6 as compared to that of treatments T1-T2, T4-T5 and T7. Treatment T3 prepared as per embodiment of the present invention showed blight severity of about 5% whereas treatment T1 and T2 depicted blight severity of about 35.3% and 25.1% respectively.

It was thus noted that the superior efficacy in terms of yield and disease control was observed with the synergistic water dispersible granular formulation as per the present invention, where the composition comprised particles in the size range of 0.1 micron-30 microns as compared to that of individual treatments and untreated.

### Experiment No 3: To Assess the Efficacy of Different Formulations of “Water-Insoluble Zinc Salt with Water-Insoluble Magnesium Salt” in Commercial Cultivated Wheat Crop Field

### Field Experiment Methodology:

The field trial was carried out to see the effect of Water dispersible granular composition comprising water insoluble Zinc with water insoluble Magnesium salt in Wheat at Punjab (Malerkotla). The trial was laid out during Rabi season in Randomized Block Design (RBD) with seven treatments including untreated control, replicated four times. For each treatment, plot size of 30 sq.m (6 m×5 m) was maintained. The test product compounds various Zinc salts with Magnesium salts alone and their combination in water dispersible granular composition as per the present invention varying concentration range with prescribed dose were applied to the soil at the time of 1^{st} irrigation of wheat (25 days after sowing). The Wheat crop in trial field was raised following good agricultural practices.

Details of experiment

a) Trial Location: Malerkotla, Punjab.
b) Crop: Wheat (var PBW-660)
c) Experiment season: Rabi 2021
d) Trial Design: Randomized Block Design
e) Replications: Four
f) Treatment: Seven
g) Plot size: 6 m × 5 m = 30 sq · m
h) Date of sowing: 10 Nov. 2021
i) Date of Application: 10 Nov. 2021
j) Method of application: Soil application
k) Date of Harvesting: 2 Jul. 2022
l) Soil pH: 6.8-7

The active dosage of Zinc and Magnesium applied in the field experiment is particularly of elemental Zinc and Magnesium. The observations were recorded at the harvesting time and the mean data was presented in Table 3 to enumerate the efficacy of the water dispersible granular composition prepared as per the embodiment of the present invention.

TABLE 3

| | Active ingredients | | Yield | | % Expected | Plant | Root | |
|---|---|---|---|---|---|---|---|---|
| | (grams/hectare) | | (Qtl/ | % Increase | Yield | Height | development | Tiller |
| Compositions | Zinc | Magnesium | hectare) | in Yield | increase | (cm) | (cm) | (cm) |
| T1- 15% Zinc Oxide + | 352 | 313 | 27 | 8 | 13.89 | 25 | 3.7 | 3.80 |
| 45% Magnesium Oxide | | | | | (0.57*) | | | |
| SC @ 2922 gm/ha as per | | | | | | | | |
| prior art composition | | | | | | | | |
| CN113214010 | | | | | | | | |
| T2- 15% Zinc Silicate | 352 | 313 | 27.9 | 11.60 | 13.89 | 29 | 3.7 | 3.90 |
| (elemental Zinc 8.8%) + | | | | | (0.83*) | | | |
| 45% Magnesium Silicate | | | | | | | | |
| Hydrate (elemental | | | | | | | | |
| Magneium 7.8%) -Powder | | | | | | | | |
| @ 4000 gm/ha | | | | | | | | |
| T3- 15% Zinc Silicate | 352 | 313 | 35 | 40.00 | 13.89 | 36 | 4.8 | 5.50 |
| (elemental Zinc 8.8%) + | | | | | (2.87*) | | | |
| 45% Magnesium Silicate | | | | | | | | |
| Hydrate (elemental | | | | | | | | |
| Magneium 7.8%) WDG@4000 | | | | | | | | |
| gm/ha as per | | | | | | | | |
| embodiment of the | | | | | | | | |
| present invention | | | | | | | | |
| T4-15% Zinc Silicate | 352 | 313 | 27.5 | 10 | 13.89 | 26 | 3.5 | 3.7 |
| (elemental Zinc 8.8%) + | | | | | (0.71*) | | | |
| 45% Magnesium Silicate | | | | | | | | |
| Hydrate (elemental | | | | | | | | |
| Magneium 7.8%) Pellets | | | | | | | | |
| @ 4000 gm/ha | | | | | | | | |
| T5- 15% Zinc Silicate | 352 | 0.0 | 26.6 | 6.40 | | 23 | 3.6 | 3.60 |
| (elemental Zinc 8.8%) | | | | | | | | |
| WDG@ 4000 gm/ha | | | | | | | | |
| T6- 45% Magnesium | 0 | 313 | 27 | 8.00 | | 24 | 3.6 | 3.60 |
| Silicate Hydrate | | | | | | | | |
| (elemental Magneium | | | | | | | | |
| 7.8%) WDG@4000 gm/ha | | | | | | | | |
| T7-Untreated | | | 25 | | | 22.00 | 3.50 | 3.20 |

SC- Suspension concentrate;
WDG- Water dispersible granule

It can be clearly seen from the Table 3 above that the treatment T3 with 15% Zinc Silicate (elemental Zinc 8.8%)+45% Magnesium Silicate Hydrate (elemental Magneium 7.8%) WDG, as per the embodiment of the present invention showed a yield increase of 40% in Wheat grains. However, treatment T1 with 15% Zinc Oxide+45% Magnesium Oxide-SC (as per the prior art) demonstrated only an increase of 8%, treatment T2 with 15% Zinc Silicate+45% Magnesium Silicate Hydrate Powder demonstrated only an increase of 11.60% while treatment T4 with 15% Zinc Silicate+45% Magnesium Silicate Hydrate Pellets demonstrated only an increase of 10%. Based on the data and the calculations made by referring the treatments T1-T5, the expected percentage increase in the fruit yield was 13.89%. The synergy factor observed with T3 is 2.87 whereas with treatment T1, T2 and T4 it was 0.57, 0.83 and 0.71 respectively. Thus, it can be noted that the treatment T3-WDG as per the present invention demonstrated a synergistic effect, as compared to the same treatment with powder composition i.e. Treatment T2, pellet composition i.e. Treatment T4 as well as the application of individual actives i.e. Treatments T5-T6 despite being applied at same dosage of applications of Zinc and Magnesium respectively. Moreover, treatment T3 also depicted better yield and plant characteristic as compared to treatment T1 (prior art composition) as well as T2 and T4. The results are all the more surprising as all the treatments T1 to T5 had the same dosage of Zinc and Magnesium being applied to the soil i.e. 352 μm/ha of Zinc and 313 μm/ha of Magnesium.

It was thus noted that composition of “water insoluble Zinc salt and water insoluble Magnesium salt” in the form of a water dispersible granule as per the embodiments of the present invention is synergistic in nature and showed a surprising enhancement in the yield as well as improved plant physiological parameters as compared to other known formulation types.

### Experiment No 4: To Assess the Impact of Particle Size Distribution in the Composition Comprising Zinc Silicate+Magnesium Silicate-WDG on Yield of Brinjal

The field trials were carried out to observe the effect of different ranges of particle size with regard to the composition of Zinc Silicate+Magnesium Silicate-WDG on the yield of Brinjal at North 24 parganas, West Bengal.

The trial was laid out during Kharif season i.e. January to April in Randomized Block Design (RBD) with four treatments including untreated control, replicated seven times. The compositions evaluated include WDG composition of Zinc salt and Magnesium salt WDG composition of the present invention as soil application after planting of brinjal seedlings in the trial plot. The brinjal crop in the trial field was raised following good agricultural practices.

Details of experiment

a) Trial Location: North 24 parganas, West Bengal
b) Crop: Brinjal
c) Experiment season: Kharif
d) Trial Design: RBD
e) Replications: Seven
f) Treatments: Four
g) Plot size: 5 × 6 = 30 sqm
h) Date of sowing: 14 Jul. 2021
i) Date of Application: 14 Jul. 2021
j) Method of application: Soil application near root zone
k) Crop variety: Pusa Purlple long
l) Date of Harvesting: 10 Dec. 2021, 25 Dec. 2021, 10 Jan. 2022

The observations were recorded at the harvesting time and the mean data was presented in Table 4 to enumerate the efficacy of the water dispersible granules comprising “Water insoluble Zinc salt and Water insoluble Magnesium salt” prepared as per the embodiment of the present invention.

TABLE 4

| | | | | Brinjal | | | |
|---|---|---|---|---|---|---|---|
| | Particle | Active ingredients | | Fruit | | Nutrient | |
| | size | (grams/hectare) | | Yield | % Increase | concentration | |
| Compositions | (micron) | Zinc | Magnesium | (Kg/ha) | in Yield | Mg | Zn |
| T1-20% Zinc Silicate | 0.1-30 | 323.25 | 193.17 | 1620 | 35.00 | 295.0 | 5.1 |
| (elemental Zinc 11.7%) + | | | | | | | |
| 40% Magnesium Silicate | | | | | | | |
| (elemental Magnesium | | | | | | | |
| 6.97%) WDG @ 2770 gm/ha | | | | | | | |
| as per embodiment | | | | | | | |
| of the present invention | | | | | | | |
| T2-20% Zinc Silicate | 0.1-50 | 323.25 | 193.17 | 1435 | 19.58 | 245.0 | 4.1 |
| (elemental Zinc 11.7%) + | | | | | | | |
| 40% Magnesium Silicate | | | | | | | |
| (elemental Magnesium | | | | | | | |
| 6.97%) WDG @ 2770 gm/ha | | | | | | | |
| T3-20% Zinc Silicate | 0.1-100 | 323.25 | 193.17 | 1400 | 16.67 | 230.0 | 3.0 |
| (elemental Zinc 11.7%) + | | | | | | | |
| 40% Magnesium Silicate | | | | | | | |
| (elemental Magnesium | | | | | | | |
| 6.97%) WDG @ 2770 gm/ha | | | | | | | |
| T4-Untreated | | | | 1200 | | 220.0 | 2.1 |

It can be seen from the data presented in Table 4 that Treatment T1 (water dispersible granular composition of 20% Zinc Silicate (elemental Zinc 11.7%)+40% Magnesium Silicate (elemental Magnesium 6.97%) WDG with particle size in the range of 0.1 micron to 30 microns as per the embodiment of the present invention showed a significant increase in the yield, when compared to treatment T2 with 20% Zinc Silicate+40% Magnesium Silicate WDG having particle size in the range of 0.1 to 50 microns, T3 with 20% Zinc Silicate+40% Magnesium Silicate WDG having particle size in the range of 0.1 to 100 microns. It was observed that the Treatment T1 showed a surprisingly significant 35% increase in the Brinjal yield whereas the treatments T2 and T3 only showed a yield increase of 19.58% and 16.67, respectively as compared to the untreated control.

Further, the uptake of nutrients such as Magnesium, Zinc was found to be very high with the Treatment T1 as compared to Treatments T2 and T3. It was thus noted that the superior efficacy in terms of yield and uptake of nutrients was observed with the water dispersible granular formulation as per the present invention, where the composition comprised particles in the size range of 0.1 micron-30 microns when compared to water dispersible granular formulations with higher particle size range.

### Experiment No. 5: To Compare the Effect of Composition of Present Invention Vis-à-Vis Commercially Available Water-Soluble Powder of Multi-Nutrient in Capsicum Crop

The field trial was carried out on a commercially cultivated Capsicum field at Nashik in Maharashtra to compare the effect of a WDG composition comprising a combination of water insoluble salts of Zinc and Magnesium vis-a-vis commercially available water-soluble multi-nutrient powder in Capsicum. The trial was laid out during spring season in Randomized Block Design (RBD) with five treatments including untreated control. The compositions of the present invention with prescribed dose were applied along with drip irrigation.

The Capsicum crop in trial field was raised following good agricultural practice.

Details of experiment

a) Trial Location: Nasik (MH)
b) Crop: Capsicum
c) Experiment season: Spring season (Jan 2022 to May 2022)
d) Trial Design: Randomized Block Design
e) Replications: Seven
f) Treatment: Three
g) Plot size: 8 m × 5 m = 40 sq · m
h) Date of planting: 10 Jan. 2022
i) Date of Application: 10 Jan. 2022
j) Method of application: Soil application by drip system

TABLE 5

| | | Fruit | | | |
|---|---|---|---|---|---|
| | Formulation | Weight | Number of | Capsicum | |
| | Dose in | (Kg/ha) of | fruits per | Fruit Yield | % Increase |
| Treatment Details | Kg/ha | 3 pickings | plant | (Kg/ha) | in Yield |
| T1-45% Zinc Oxide + 35% | 4 | 50 | 9 | 30100 | 42.9 |
| Magnesium Silicate -WDG | | | | | |
| as per the embodiment of | | | | | |
| present invention. | | | | | |
| T2- Nutrifast | 8 | 39 | 4 | 22550 | 7.1 |
| (commercially available | | | | | |
| water soluble product by | | | | | |
| Stanes) (40% NPK + 5% | | | | | |
| micronutrient mixture) | | | | | |
| T3-Untreated | — | 32 | 3 | 21050 | — |

It can be observed from treatment T1 of Table 5 that a WDG composition prepared according to an embodiment of the present invention demonstrated better yield as compared to treatment T2 wherein the composition applied is a commercially available water soluble multi-nutrient mixture and the untreated plot. Treatment T1 depicted yield increase of about 42% when compared to treatment T2 which had yield increase of only 7.1% despite being applied at higher dosage. Thus, it can be concluded that even at a reduced dosage, the combination of “water insoluble Zinc salt and water insoluble Magnesium salt” in the form of WDG as per the embodiment of the present invention shows significant improvement in fruit weight, number of fruits and fruit yield than that of the commercially available water soluble multi-nutrient mixture.

### Experiment 6: To Study Efficacy of the Composition of the Present Invention on Cucumber Crop

The field trial was carried out to see the effect of Water dispersible granular composition comprising water insoluble Zinc with water insoluble Magnesium salt in Cucumber at Indore. The trial was laid out during Kharif season in Randomized Block Design (RBD) with five treatments including untreated control, replicated four times. For each treatment, plot size of 30 sq.m (6 m×5 m) was maintained. The test product compounds various Zinc salts, Magnesium salts alone and their combination in water dispersible granular composition as per the present invention varying concentration range with prescribed dose were applied foliar at pre-flowering stage. The Cucumber crop in trial field was raised following good agricultural practices.

The Details of the Experiment are as follows:

a) Trial Location: Indore, MP
b) Crop: Cucumber (Var-Malini)
c) Experiment season: Kharif 2021 (July 2021 to Nov 2021)
d) Trial Design: Randomized Block Design
e) Replications: 4
f) Treatment: 5
g) Plot size: 5 × 6 = 30 sqm
h) Date of Application: 25 Aug. 2021
i) Date of sowing planting: 6 Jul. 2021
j) Method of application: Foliar application (Pre-flowering)
k) Date of Harvesting: 17 Oct. 2021
l)Soil pH: 7.5

The observations on flowering were recorded 40DAA and mean data of fruit yield at the time of harvest were presented in Table 6.

TABLE 6

| | | | Flowering | | | |
|---|---|---|---|---|---|---|
| | | | per plant | | | |
| | Active ingredient | | (Mean of | | % Increase | Expected |
| | gm/ha | | 5 plants) | Yield | in | yield |
| Treatment Details | Zinc | Magnesium | 40DAA | (Kg/ha) | Yield | increase |
| T1: 25% Zinc Carbonate | 247 | 401 | 21 | 12020 | 49.65 | 23.61 |
| (elemental Zinc 13%) + | | | | | | |
| 35% Magnesium Oxide | | | | | | |
| (elemental Magnesium | | | | | | |
| 21.1%) WDG@1900 gm/ha | | | | | | |
| as per embodiment of | | | | | | |
| the present invention | | | | | | |
| T2: 25% Zinc Carbonate | 247 | | 15.2 | 9013 | 12.21 | |
| (elemental Zinc | | | | | | |
| 13%)WDG@1900 gm/ha | | | | | | |
| T3: 35% Magnesium | | 401 | 13.5 | 9075 | 12.98 | |
| Oxide (elemental | | | | | | |
| Magnesium 21.1%) | | | | | | |
| WDG@1900 gm/ha | | | | | | |
| T4: 25% Zinc oxide + | 247 | 401 | 16.9 | 9700 | 20.7 | |
| 35% Magnesium Oxide | | | | | | |
| SC as per prior art | | | | | | |
| CN113214010 | | | | | | |
| T5-Untreated | | | 12 | 8032 | | |

It can be seen from the data presented in Table 6 that Treatment T1 (water dispersible granular composition of 25% Zinc Carbonate (elemental Zinc 13%)+35% Magnesium Oxide (elemental Magnesium 21.1%) WDG (with particle size in the range of 0.1 micron to 30 microns) as per the embodiment of the present invention showed a significant increase in flowering and subsequently the yield, when compared to treatment T2 (25% Zinc Carbonate WDG), treatment T3 (35% Magnesium Oxide WDG) and treatment T4 (25% Zinc Oxide+35% Magnesium Oxide SC as per prior art). This clearly indicates that the foliar application of the composition of the present invention (treatment T1) significantly increased the flowering in Cucumber as compared to treatments T2 (25% Zinc Carbonate WDG), T3 (35% Magnesium Oxide WDG) as well as treatment T4 and untreated. It was further observed that by the application of Treatment T1 as per the embodiment of the present invention, the dropping off of the Cucumber fruit was remarkably reduced which in turn helps to increase the number of fruits and thereby the fruit yield significantly as compared to the dropping off of the Cucumber fruit observed with the application of treatments T2-T5.

Further, the % increase in fruit yield observed with treatment T1 was about 49.65% whereas with treatment T2, T3 and T4 it was about 12%, 21%, 12.98% and 20.7% respectively. It was thus noted that the superior efficacy in terms of reduced flower and fruit drop and yield was observed with water dispersible granular formulation as per the present invention, where the composition comprised particles in the size range of 0.1 micron-30 microns when applied foliar compared to other treatments.

### Experiment 7: To Study the Effect of Composition of the Present Invention in Comparison to Traditional Fertilizer Practices on the Uptake of Nutrients on Cabbage Crop

The pot trial experiments were carried out to determine the effect of composition of the present invention on availability of nutrients with that of the application of traditional fertilizer practices in Poly-house at Nashik, Maharashtra (India).

Soil was analyzed to assess nutrient availability before the date of application of treatment and the observations are as follow:

| N | P | K | Zn | Mg | Ca | Mn | B |
|---|---|---|---|---|---|---|---|
| 6800 | 1500 | 4100 | 15 | 260 | 7 | 3.5 | 0.7 |
| mg/ha | mg/ha | mg/ha | ppm | ppm | ppm | ppm | ppm |

The Test Nutritional Compositions as indicated in below at prescribed dose were measured based on surface area calculation of soil and applied in the respective treatment pots on top soil and mixed in soil well up to 5 cm depth. Thereafter, a 25 days old cabbage seedling was planted in each pot. The planted cabbage seedlings in the 7 pots were raised with GAP (Good Agricultural Practice) until harvesting or full development of cabbage. The treatment details are as follows:

The Details of the Experiment are as follows:

a) Trial Location: Nashik
b) Crop: Cabbage (Var-Royal Vantage)
c) Experiment season: Rabi (Nov 2021 to Feb 2022)
d) Trial Design: Randomized Block Design with 5 pot in
each treatment
e) Replications: 5
f) Treatment: 7
g) Pot size: 20 cm top diameter X 15.5 cm bottom
diameter x

TABLE 7

| | Formulation | Soil pH | | Nutrient content available in final | | | | | | | |
|---|---|---|---|---|---|---|---|---|---|---|---|
| | dosage in | | At | produce (mg/kg of Cabbage Head) | | | | | | | |
| Compositions | g/ha | BA | harvest | N | P | K | Mg | Zn | B | Mn | Ca |
| T1- Zinc Oxide | 1500 | 5.8 | 7.0 | 6500 | 860 | 3800 | 240 | 15 | 0.5 | 2 | 6 |
| (elemental Zinc 12%) | | | | | | | | | | | |
| 15% + Magnesium | | | | | | | | | | | |
| Silicate Hydrate 45 | | | | | | | | | | | |
| (elemental | | | | | | | | | | | |
| Magnesium 7.8%) | | | | | | | | | | | |
| %-WDG prepared as | | | | | | | | | | | |
| per the embodiment | | | | | | | | | | | |
| of the present | | | | | | | | | | | |
| invention | | | | | | | | | | | |
| T2- Zinc Carbonate | 1500 | 5.8 | 7.0 | 63 | 855 | 390 | 210 | 17 | 0.4 | 1.7 | 5.5 |
| 5% (elemental Zinc | | | | | | | | | | | |
| 2.6%) + Magnesium | | | | | | | | | | | |
| Oxide 80% | | | | | | | | | | | |
| (elemental | | | | | | | | | | | |
| Magnesium 48%) - | | | | | | | | | | | |
| WDG prepared as per | | | | | | | | | | | |
| the embodiment of | | | | | | | | | | | |
| the present invention | | | | | | | | | | | |
| T3- NPK traditional | 1000 | 5.8 | 6 | 2500 | 350 | 1800 | 90 | 2.3 | 0.2 | 1.4 | 2.5 |
| Fertilizer 19:19:19 | | | | | | | | | | | |
| (water soluble | | | | | | | | | | | |
| commercially | | | | | | | | | | | |
| available mixture) | | | | | | | | | | | |
| T4-Nutrifast | 2500 | 5.8 | 6 | 2600 | 370 | 1900 | 110 | 3.7 | 0.2 | 1.5 | 3 |
| (commercially | | | | | | | | | | | |
| available water | | | | | | | | | | | |
| soluble product by | | | | | | | | | | | |
| Stanes) (40% NPK + | | | | | | | | | | | |
| 5% micronutrient | | | | | | | | | | | |
| mixture) | | | | | | | | | | | |
| T5- Zinc Oxide 15% WDG | 1500 | 5.8 | 6 | 2400 | 290 | 100 | 75 | 0.9 | 0.1 | 1.1 | 1.3 |
| T6- Zinc Carbonate 5% WDG | 1500 | 5.8 | 6 | 20 | 210 | 80 | 70 | 0.7 | 0.1 | 1.0 | 0.9 |
| T7- Untreated | | 5.8 | 6 | | 1900 | 270 | 55 | 2.5 | 0.1 | 1 | 1.5 |

BA* Before application

It can also be observed from Table 7 that treatment T1 and treatment T2, a WDG composition prepared according to an embodiment of the present invention demonstrated better uptake of nutrients as compared to treatments T3 and T4 wherein the water soluble NPK fertilizers and NPK with water soluble micronutrient composition (Nutrifast by Stanes) as well as over the untreated plot.

It was noted that with Treatment T1 and T2, Zinc and Magnesium were made immediately available to the crops along with other nutrients present in the soil whereas the uptake of Zinc or Magnesium was found to be lesser in treatments T3, T4 and T5. It was also observed that the practice of application of NPK and NPK with other micronutrients such as Calcium, Boron, Manganese etc. even at higher dosage still failed to provide significant uptake of Zinc and Magnesium as observed with the composition of the present invention. Further it was observed that with treatments T2-T6, the uptake of zinc was found to be lower due to the presence of phosphorous in the soil which blocked Zinc and thus interferes with its absorption in plant. However, it was observed that the application of treatment T1 and T2 which was prepared as per embodiment of the present invention having presence of Magnesium and its synergy with Zinc in a Water dispersible granular composition with particle size of 0.1 to 30 microns demonstrates not only enhanced the uptake of Zinc but also of other nutrients such as Magnesium, Manganese Boron etc as compared to treatments T3-T6.

Moreover, it was also observed that even when soil was enriched with nutrients, uptake of nutrients was lesser with Treatments T3 and T4 despite being applied in higher amounts. However, increased uptake of nutrients was observed with composition of the present invention as the said composition created a suitable environment for uptake of nutrients, corrects the soil pH and thereby assisted in unlocking nutrients from soil to the plant or crops. It was further noted that the Treatment T3 and T4 depicted nutrient antagonism due to higher phosphorous presence in acidic soil which hampered uptake of Zinc and Magnesium. Thus, it can be concluded that composition of the present invention not only facilitates assimilation of essential nutrients like Magnesium and Zinc but also assist in unlocking the micronutrients and trace elements making them available for uptake by plants which were not available for uptake in soil.

It is thus noted that, the WDG composition of “water insoluble zinc salt and water insoluble Magnesium salt” as per the embodiments of the present invention in the size range of 0.1-30 microns provided significantly higher amount of magnesium and zinc available even in presence of NPK fertilizer which was not observed with application of traditional fertilizers alone.

Further, the inventors of the present invention also tested the WDG composition of the present invention on other crops like Chili, Maize. It was observed that the composition of the present invention may further enhance crop characteristics like straw weight, plant height and also add to nutritional value of the crop. Further such combinations may additionally help in improving the crop yield, improved photosynthesis, increase chlorophyll content and uptake of nutrients by the crop.

It has been observed that the composition of the present invention, demonstrates enhanced, efficacious and superior behavior in the fields. Through the composition of the present invention, the number of applications or the amount of nutrients, fertilizers or pesticides are minimized. Moreover, the present composition exhibits a surprisingly higher field efficacy at reduced dosages of application of the composition as compared to prior known composition. The composition is highly safe for the user and for the environment. This novel composition helps to improve plant yield, balanced uptake of all nutrients, reduce yellowing of leaves and plant physiological parameters such as increased rooting, improved foliage, disease resistance, increased greenness of the crops providing a nutritionally rich crop.

Further, the various advantageous properties associated with the compositions according to the invention, include but are not limited to improved stability, improved toxicological and/or ecotoxicological behavior, improved crop characteristics including crop yields, crop qualities and characteristics and other advantages familiar to a person skilled in the art.

From the foregoing, it will be observed that numerous modifications and variations can be effectuated without departing from the true spirit and scope of the novel concepts of the present invention. It is to be understood that no limitation with respect to the specific embodiments illustrated is intended or should be inferred.

I claim:

1. A water dispersible granular crop nutrition composition comprising a homogeneous mixture of:
at least one water insoluble Zinc salt in the range of 1%-50% w/w of the total composition,
at least one water insoluble Magnesium salt in the range of 5%-80% w/w of the total composition,
at least one agrochemically acceptable excipient,
wherein the elemental Zinc is present in the range of 0.01% to 50% by weight of the total composition and
wherein the elemental Magnesium is present in the range of 0.1% to 50% by weight of the total composition, and wherein the composition comprises particles in the size range of 0.1 micron-30 microns.

2. The composition as claimed in claim 1, wherein at least one water insoluble Zinc salt comprises at least one of Zinc Oxide, Zinc Carbonate, Zinc Sulphide, Zinc Molybdate, Zinc Phosphate, Zinc Nitrilotriacetic Acid, Zinc Borate, Zinc Silicate, Zinc Pyrophosphate and Zinc Citrate.

3. The composition as claimed in claim 1, wherein at least one water insoluble Magnesium salt comprises at least one of Magnesium Molybdate, Magnesium Hydroxide, Calcium Magnesium Phosphate, Magnesium Carbonate, Magnesium Aluminium Silicate, Calcium Magnesium Silicate, Magnesium Trisilicate, Magnesium Silicate, Magnesium Oxide.

4. The composition as claimed in claim 1, wherein granules of the composition are in the size range of 0.05-5.0 mm

5. The composition as claimed in claim 1, wherein the composition comprises of particles in the size range of 0.1 micron to 20 microns.

6. The composition as claimed in claim 1, wherein the composition comprises particles having diameter distribution of D50 of about 20 microns.

7. The composition as claimed in claim 1, wherein at least one agrochemically acceptable excipient is selected from one or more of wetting agents, surfactants, dispersing agents, disintegrating agents, hydrocolloids, emulsifiers, fillers or carriers or diluents, spreading agents, colorants, anticaking agents, binders, buffers or pH adjusters or neutralizing agents, tackifiers, pigments, stabilizers, antifoaming agents or defoamers, anti-settling agents, penetrants, preservatives.

8. The composition as claimed in claim 1, wherein the agrochemically acceptable excipient comprises at least one surfactant.

9. The composition as claimed in claim 1, wherein at least one agrochemically acceptable excipient is in the range of 0.01%-94% w/w of the total composition.

10. The composition as claimed in claim 1, wherein suspensibility of the composition is at least 30%.

11. A process for preparation of water dispersible granular crop nutrition composition as claimed in claim 1, wherein the process comprises:
a. milling a homogeneous mixture of at least one water insoluble Zinc salt in the range of 1%-50% w/w of the total composition; at least one water insoluble Magnesium salt in the range of 5%-80% w/w of the total composition and at least one agrochemically acceptable excipient in water to obtain a slurry or wet mix,
b. drying the slurry or wet mix to obtain a water dispersible granular composition; wherein the elemental Zinc is present in the range of 0.01% to 50% by weight of the total composition and wherein the elemental Magnesium is present in the range of 0.1% to 50% by weight of the total composition and wherein the composition comprises particles in the size range of 0.1 micron to 30 microns.

12. A composition as claimed in claim 1, wherein the composition is at least one of a fertilizer composition, a nutrient composition, a crop strengthener composition, a soil conditioner composition and a yield enhancer composition.

13. A method for improving plant health or enhancing the uptake of nutrient by the plants or plant yield wherein the method comprises treating at least one of a plant, a plant propagation material, locus or plant parts, a seed, seedling; or surrounding soil with the water dispersible granular composition as claimed in claim 1.
